(19) United States
(12) Patent Application Publication
(10) Pub. No.: US 2025/0225746 A1
(43) Pub. Date: Jul. 10, 2025

(54) WEARABLE DEVICE AND METHOD FOR CHANGING VISUAL OBJECT BY USING DATA IDENTIFIED BY SENSOR

(71) Applicant: Samsung Electronics Co., Ltd., Suwon-si (KR)

(72) Inventors: Choelmin PARK, Suwon-si (KR); Sungoh KIM, Suwon-si (KR); Jaeyung YEO, Suwon-si (KR); Chungwan HONG, Suwon-si (KR)

(21) Appl. No.: 19/091,204

(22) Filed: Mar. 26, 2025

Related U.S. Application Data
(63) Continuation of application No. PCT/KR2023/015041, filed on Sep. 27, 2023.

(30) Foreign Application Priority Data
Oct. 26, 2022 (KR) 10-2022-0139624

(51) Int. Cl. G06T 19/00; G06F 3/01; G06V 20/20

(52) U.S. Cl. CPC G06T 19/006; G06F 3/011; G06V 20/20

(57) ABSTRACT

A wearable device may display a visual object within a user's field-of-view (FoV) and obtain motion information indicating a motion related to the user from a camera and a sensor. The wearable device may identify whether the motion indicated by the motion information corresponds to a motion specified in object information matched to the visual object change the visual object based on the object information, based on identifying the motion corresponding to the specified motion.

### CROSS-REFERENCE TO RELATED APPLICATIONS

This application is a continuation of International Application No. PCT/KR2023/015041, designating the United States, filed on Sep. 27, 2023, in the Korean Intellectual Property Receiving Office, and claiming priority to Korean Patent Application No. 10-2022-0139624, filed on Oct. 26, 2022, in the Korean Intellectual Property Office, the disclosures of each of which are incorporated by reference herein in their entireties.

### BACKGROUND

### Field

The present disclosure relates to a wearable device and a method for changing a visual object by using data identified by a sensor.

### Description of Related Art

In order to provide an enhanced user experience, an electronic device is being developed that provides an augmented reality (AR) service that displays information generated by a computer in linkage with an external object in the real world. The electronic device may be a wearable device that may be attached to a user. For example, the electronic device may be AR glasses and/or a head-mounted device (HMD).

### SUMMARY

According to an example embodiment, a wearable device may include a camera, a sensor, a display, memory comprising one or more storage media storing instructions, and at least one processor (including, e.g., processing circuitry). The instructions, when executed by the at least one processor individually or collectively, cause the wearable device to display, in a state in which the wearable device is attached to a user, a visual object in a field-of-view (FoV) of the user by using the display. The instructions, when executed by the at least one processor individually or collectively, cause the wearable device to obtain, from the camera and the sensor, sensor information indicating a motion associated with the user. The instructions, when executed by the at least one processor individually or collectively, cause the wearable device to identify whether the motion indicated by the sensor information corresponds to a preset motion in object information matched to the visual object. The instructions, when executed by the at least one processor individually or collectively, cause the wearable device to change, based on identifying the motion corresponding to the preset motion, the visual object displayed in the FoV, based on the object information matched to the preset motion.

According to an example embodiment, a method of a wearable device may include displaying, in a state in which the wearable device is attached to a user, a visual object in a field-of-view (FoV) of the user using a display in the wearable device; obtaining, from a camera in the wearable device and a sensor in the wearable device, sensor information indicating a motion associated with the user; identifying whether the motion indicated by the sensor information corresponds to a preset motion in object information matched to the visual object; and, based on identifying the motion corresponding to the preset motion, changing the visual object displayed in the FoV, based on the object information matched to the preset motion.

According to an example embodiment, a wearable device may include a sensor, a display, and at least one processor (including, e.g., processing circuitry). The at least one processor may be configured to display, in a state in which the wearable device is attached to a user, a plurality of visual objects in a field-of-view (FoV) of the user using the display; identify, based on identifying a preset motion associated with a first external electronic device based on the sensor, a location in the FoV of a second external electronic device corresponding to the first external electronic device; and change at least one visual object associated with the location in the FoV among the plurality of visual objects, based on object information corresponding to the at least one visual object.

According to an example embodiment, a method of a wearable device may include displaying, in a state in which the wearable device is attached to a user, a plurality of visual objects in a field-of-view (FoV) of the user using a display in the wearable device; identifying, based on identifying a preset motion associated with a first external electronic device based on a sensor in the wearable device, a location in the FoV of a second external electronic device corresponding to the first external electronic device; and changing at least one visual object associated with the location in the FoV among the plurality of visual objects, based on object information corresponding to the at least one visual object.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram for an example first environment in which a metaverse service is provided through a server according to various embodiments;

FIG. 2 is a diagram of an example second environment in which a metaverse service is provided through direct connection between user terminals and a second terminal according to various embodiments;

FIG. 3A illustrates a perspective view of an example wearable device, according to various embodiments;

FIG. 3B illustrates an example of one or more hardware disposed in an example wearable device according to various embodiments;

FIG. 4A and FIG. 4B illustrate an exterior of an example wearable device, according to various embodiments;

FIG. 5 illustrates an operation performed by an example wearable device based on data of a camera and/or a sensor, according to various embodiments;

FIG. 6 is a block diagram of an example wearable device, according to various embodiments;

FIG. 7 illustrates an example operation performed by an example wearable device based on a state of an external electronic device identified through a sensor, according to various embodiments;

FIG. 8 illustrates an example operation performed by an example wearable device based on a motion of a user, according to various embodiments;

FIG. 9 illustrates an example operation performed by an example wearable device based on an external object, according to various embodiments;

FIG. 10A and FIG. 10B illustrate an example operation of displaying a visual object linked to an external object by a wearable device according to various embodiments;

FIG. 11 illustrates a flowchart of example operations of an example wearable device according to various embodiments;

FIG. 12 illustrates a flowchart of example operations of an example wearable device according to various embodiments; and

FIG. 13 illustrates a flowchart of example operations of an example wearable device according to various embodiments.

### DETAILED DESCRIPTION

Hereinafter, various example embodiments of the present disclosure will be described with reference to the accompanying drawings.

The various example embodiments of the present disclosure and terms used herein are not intended to limit the technology described in the present disclosure to specific embodiments, and should be understood to include various modifications, equivalents, or substitutes of the corresponding embodiment. In relation to the description of the drawings, a same reference numeral may be used for a same or similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but do not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, or any combination thereof, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

Metaverse is a compound word of the English word ‘meta’ meaning ‘virtual’ or ‘transcendence’ and ‘universe’ meaning the universe, and refers to a three-dimensional virtual world where social, economic, and cultural activities as in the real world take place. The metaverse is a more advanced concept than virtual reality (VR, state-of-the-art technology that enables people to have a realistic experience in a computer-generated virtual world) and is characterized by not only enjoying a game or virtual reality but also social and cultural activities as in real reality by utilizing an avatar.

Such a metaverse service may be provided in at least two forms. The first is form is a service provided to a user using a server, and the second form is a service provided through an individual contact between users.

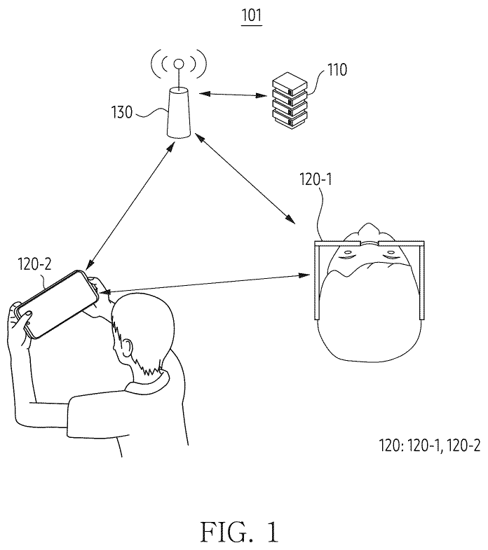

FIG. 1 is a diagram of an example first environment 101 in which a metaverse service is provided through a server 110 according to various embodiments.

Referring to FIG. 1, the first environment 101 is configured with the server 110 providing the metaverse service, a network (e.g., a network formed by at least one intermediate node 130 including an access point (AP) and/or a base station) connecting the server 110 with each user terminal (e.g., a user terminal 120 including a first terminal 120-1 and a second terminal 120-2), and the user terminal enables the user to utilize a metaverse service by accessing a server through a network and inputting/outputting data for the service.

At this time, the server 110 may provide a virtual space so that the user terminal 120 may be active in the virtual space. In addition, the user terminal 120 may represent information provided by the server 110 to the user or transmit information that the user wants to represent in the virtual space to the server, by installing an S/W agent for accessing the virtual space provided by the server 110.

The S/W agent may be provided, for example, directly through the server 110, downloaded from a public server, or embedded and provided when purchasing a terminal.

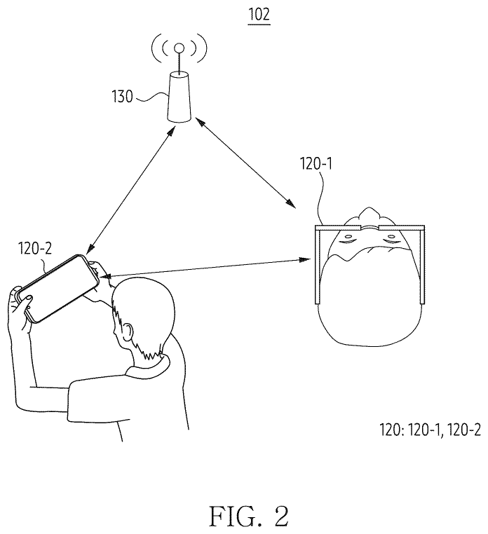

FIG. 2 is a diagram of an example second environment 102 in which a metaverse service is provided through direct connection between user terminals (e.g., a first terminal 120-1 and a second terminal 120-2) according to various embodiments.

Referring to FIG. 2, the second environment 102 is configured with the first terminal 120-1 that provides the metaverse service, a network (e.g., a network formed by at least one intermediate node 130) connecting each user terminal, and the second terminal 120-2 that causes a second user to use a service by inputting and outputting to the metaverse service accessing the first terminal 120-1 through the network.

A second environment is characterized by providing the metaverse service, as the first terminal 120-1 performs a role of a server (e.g., the server 110 of FIG. 1) in a first environment. That is, it may be known that a metaverse environment may be configured simply by connecting, for example, a first device and a second device.

In the first environment and the second environment, the user terminal 120 (or the user terminal 120 including the first terminal 120-1 and the second terminal 120-2) may be produced in various form factors, and is characterized by including an output device for providing an image and/or a sound to the user and an input device for inputting information to the metaverse service. As an example of various form factors of the user terminal 120, it may include a smartphone (e.g., the second terminal 120-2), an AR device (e.g., the first terminal 120-1), a virtual reality (VR) device, a mixed reality (MR) device, a video see-through (VST) device, and a TV or a projector capable of input and output.

The network (e.g., the network formed by the at least one intermediate node 130) of the present invention includes all of various broadband networks including 3G, 4G, and 5G and a short-range network (e.g., a wired network or a wireless network directly connecting the first terminal 120-1 and the second terminal 120-2) including wireless fidelity (WiFi) and Bluetooth™ (BT).

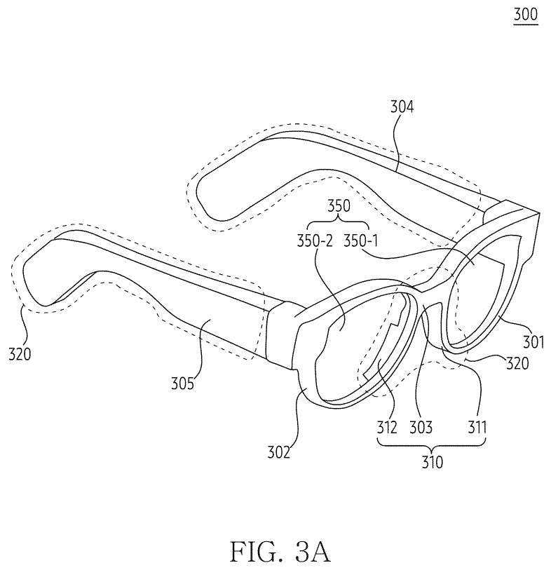

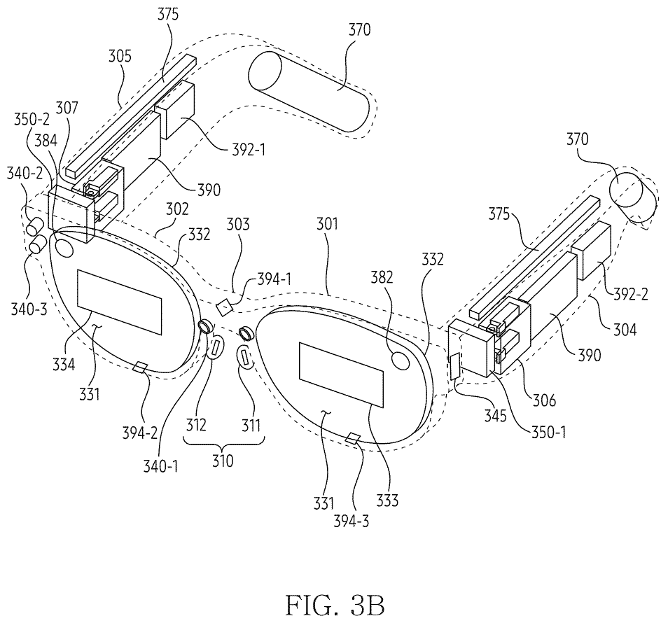

FIG. 3A illustrates a perspective view of an example wearable device 300 according to various embodiments. FIG. 3B illustrates one or more hardware disposed in an example wearable device 300 according to various embodiments. The wearable device 300 of FIGS. 3A and 3B may include the first terminal 120-1 of FIGS. 1 and 2. As shown in FIG. 3A, according to an example embodiment, the wearable device 300 may include at least one display 350 and a frame supporting the at least one display 350.

According to an embodiment, the wearable device 300 may be worn on a part of the user's body. The wearable device 300 may provide augmented reality (AR), virtual reality (VR), or mixed reality (MR) in which augmented reality and virtual reality are mixed to a user wearing the wearable device 300. For example, the wearable device 300 may output a virtual reality image to the user through at least one display 350 in response to the user's designated gesture obtained through a motion recognition camera 340-2 of FIG. 3B.

According to an embodiment, the at least one display 350 in the wearable device 300 may provide visual information to a user. For example, the at least one display 350 may include a transparent or translucent lens. The at least one display 350 may include a first display 350-1 and/or a second display 350-2 spaced apart from the first display 350-1. For example, the first display 350-1 and the second display 350-2 may be disposed at positions corresponding to the user's left and right eyes, respectively.

Referring to FIG. 3B, the at least one display 350 may form a display area on the lens to provide a user wearing the wearable device 300 with visual information included in ambient light passing through the lens and other visual information distinct from the visual information. The lens may be formed based on at least one of a fresnel lens, a pancake lens, or a multi-channel lens. The display area formed by the at least one display 350 may be formed on the second surface 332 of the first surface 331 and the second surface 332 of the lens. When the user wears the wearable device 300, ambient light may be transmitted to the user by being incident on the first surface 331 and being penetrated through the second surface 332. For example, the at least one display 350 may display a virtual reality image to be coupled with a reality screen transmitted through ambient light. The virtual reality image outputted from the at least one display 350 may be transmitted to eyes of the user, through one or more hardware (e.g., optical devices 382 and 384, and/or at least one waveguides 333 and 334) included in the wearable device 300.

According to an embodiment, the wearable device 300 may include waveguides 333 and 334 that transmit light transmitted from the at least one display 350 and relayed by the at least one optical device 382 and 384 by diffracting to the user. The waveguides 333 and 334 may be formed using, for example, at least one of glass, plastic, or polymer. A nano pattern may be formed on at least a portion of the outside or inside of the waveguides 333 and 334. The nano pattern may be formed based on a grating structure having a polygonal or curved shape. Light incident to an end of the waveguides 333 and 334 may be propagated to another end of the waveguides 333 and 334 by the nano pattern. The waveguides 333 and 334 may include at least one of at least one diffraction element (e.g., a diffractive optical element (DOE), a holographic optical element (HOE)), and a reflection clement (e.g., a reflection mirror). For example, the waveguides 333 and 334 may be disposed in the wearable device 300 to guide a screen displayed by the at least one display 350 to the user's eyes. For example, the screen may be transmitted to the user's eyes through total internal reflection (TIR) generated in the waveguides 333 and 334.

According to an example embodiment, the wearable device 300 may analyze an object included in a real image collected through a photographing camera 340-3, combine with a virtual object corresponding to an object that becomes a subject of augmented reality provision among the analyzed object, and display on the at least one display 350. The virtual object may include at least one of text or images for various information associated with the object included in the real image. The wearable device 300 may analyze the object based on a multi-camera such as a stereo camera. For the object analysis, the wearable device 300 may execute time-of-flight (ToF) and/or simultaneous localization and mapping (SLAM) supported by the multi-camera. The user wearing the wearable device 300 may watch an image displayed on the at least one display 350.

According to an embodiment, a frame may be configured with a physical structure in which the wearable device 300 may be worn on the user's body. According to an embodiment, the frame may be configured so that when the user wears the wearable device 300, the first display 350-1 and the second display 350-2 may be positioned corresponding to the user's left and right eyes. The frame may support the at least one display 350. For example, the frame may support the first display 350-1 and the second display 350-2 to be positioned at positions corresponding to the user's left and right eyes.

Referring to FIG. 3A, according to an embodiment, the frame may include an area 320 at least partially in contact with the portion of the user's body in a case that the user wears the wearable device 300. For example, the area 320 of the frame in contact with the portion of the user's body may include an area in contact with a portion of the user's nose, a portion of the user's car, and a portion of the side of the user's face that the wearable device 300 contacts. According to an embodiment, the frame may include a nose pad 310 that is contacted on the portion of the user's body. When the wearable device 300 is worn by the user, the nose pad 310 may be contacted on the portion of the user's nose. The frame may include a first temple 304 and a second temple 305, which are contacted on another (second) portion of the user's body that is distinct from the (first) portion of the user's body.

According to an embodiment, the frame may include a first rim 301 surrounding at least a portion of the first display 350-1, a second rim 302 surrounding at least a portion of the second display 350-2, a bridge 303 disposed between the first rim 301 and the second rim 302, a first pad 311 disposed along a portion of the edge of the first rim 301 from one end of the bridge 303, a second pad 312 disposed along a portion of the edge of the second rim 302 from the other end of the bridge 303, the first temple 304 extending from the first rim 301 and fixed to a portion of the wearer's car, and the second temple 305 extending from the second rim 302 and fixed to a portion of the (second) car opposite to the (first) car. The first pad 311 and the second pad 312 may be in contact with the portion of the user's nose, and the first temple 304 and the second temple 305 may be in contact with a portion of the user's face and the portion of the user's car. The temples 304 and 305 may be rotatably connected to the rim through hinge units 306 and 307 (each including, e.g., a hinge) of FIG. 3B. The first temple 304 may be rotatably connected with respect to the first rim 301 through the first hinge unit 306 disposed between the first rim 301 and the first temple 304. The second temple 305 may be rotatably connected with respect to the second rim 302 through the second hinge unit 307 disposed between the second rim 302 and the second temple 305. According to an embodiment, the wearable device 300 may identify an external object (e.g., a user's fingertip) touching the frame and/or a gesture performed by the external object using a touch sensor, a grip sensor, and/or a proximity sensor formed on at least a portion of the surface of the frame.

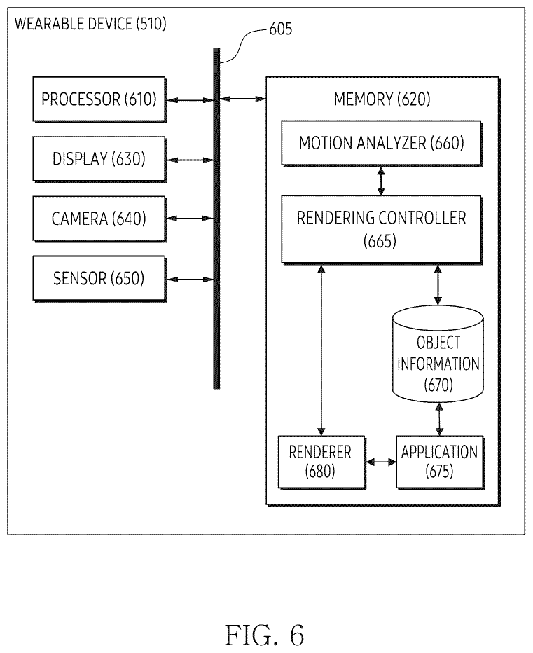

According to an embodiment, the wearable device 300 may include hardware (e.g., hardware described based on the block diagram of FIG. 6) that performs various functions. For example, the hardware may include a battery module 370, an antenna module 375, optical devices 382 and 384, speakers 392-1 and 392-2, microphones 394-1, 394-2, and 394-3, a depth sensor module (not illustrated), and/or a printed circuit board (PCB) 390. Various hardware may be disposed in the frame.

According to an embodiment, the microphones 394-1, 394-2, and 394-3 of the wearable device 300 may obtain a sound signal, by being disposed on at least a portion of the frame. The first microphone 394-1 disposed on the nose pad 310, the second microphone 394-2 disposed on the second rim 302, and the third microphone 394-3 disposed on the first rim 301 are illustrated in FIG. 3B, but the number and disposition of the microphone(s) 394 are not limited to an embodiment of FIG. 3B. In a case that the number of the microphone(s) 394 included in the wearable device 300 is two or more, the wearable device 300 may identify a direction of the sound signal using a plurality of microphones disposed on different portions of the frame.

According to an embodiment, the optical devices 382 and 384 may transmit a virtual object transmitted from the at least one display 350 to the wave guides 333 and 334. For example, the optical devices 382 and 384 may be projectors. The optical devices 382 and 384 may be disposed adjacent to the at least one display 350 or may be included in the at least one display 350 as a portion of the at least one display 350. The first optical device 382 may correspond to the first display 350-1, and the second optical device 384 may correspond to the second display 350-2. The first optical device 382 may transmit light outputted from the first display 350-1 to the first waveguide 333, and the second optical device 384 may transmit light outputted from the second display 350-2 to the second waveguide 334.

In an embodiment, a camera 340 may include an eye tracking camera (ET CAM) 340-1, a motion recognition camera 340-2 and/or the photographing camera 340-3. The photographing camera 340-3, the eye tracking camera 340-1, and the motion recognition camera 340-2 may be disposed at different positions on the frame and may perform different functions. The eye tracking camera 340-1 may output data indicating a gaze of the user wearing the wearable device 300. For example, the wearable device 300 may detect the gaze from an image including the user's pupil, obtained through the eye tracking camera 340-1. An example in which the eye tracking camera 340-1 is disposed toward the user's right eye is illustrated in FIG. 3B, but the embodiment is not limited thereto, and the eye tracking camera 340-1 may be disposed alone toward the user's left eye or may be disposed toward two eyes.

In an embodiment, the photographing camera 340-3 may photograph a real image or background to be matched with a virtual image in order to implement the augmented reality or mixed reality content. The photographing camera may photograph an image of a specific object existing at a position viewed by the user and may provide the image to the at least one display 350. The at least one display 350 may display one image in which a virtual image provided through the optical devices 382 and 384 is overlapped with information on the real image or background including the image of the specific object obtained by using the photographing camera. In an embodiment, the photographing camera may be disposed on the bridge 303 disposed between the first rim 301 and the second rim 302.

In an embodiment, the eye tracking camera 340-1 may implement a more realistic augmented reality by matching the user's gaze with the visual information provided on the at least one display 350, by tracking the gaze of the user wearing the wearable device 300. For example, when the user looks at the front, the wearable device 300 may naturally display environment information associated with the user's front on the at least one display 350 at a position where the user is positioned. The eye tracking camera 340-1 may be configured to capture an image of the user's pupil in order to determine the user's gaze. For example, the eye tracking camera 340-1 may receive gaze detection light reflected from the user's pupil and may track the user's gaze based on the position and movement of the received gaze detection light. In an embodiment, the eye tracking camera 340-1 may be disposed at a position corresponding to the user's left and right eyes. For example, the eye tracking camera 340-1 may be disposed in the first rim 301 and/or the second rim 302 to face the direction in which the user wearing the wearable device 300 is positioned.

The motion recognition camera 340-2 may provide a specific event to the screen provided on the at least one display 350 by recognizing the movement of the whole or portion of the user's body, such as the user's torso, hand, or face. The motion recognition camera 340-2 may obtain a signal corresponding to motion by recognizing the user's gesture, and may provide a display corresponding to the signal to the at least one display 350. A processor may identify a signal corresponding to the operation and may perform a preset function based on the identification. In an embodiment, the motion recognition camera 340-2 may be disposed on the first rim 301 and/or the second rim 302.

According to an embodiment, the camera 340 included in the wearable device 300 is not limited to the above-described eye tracking camera 340-1 and the motion recognition camera 340-2. For example, the wearable device 300 may identify an external object included in the FoV by using a photographing camera 340-3 disposed toward the user's FoV. The wearable device 300 identifying the external object may be performed based on a sensor for identifying a distance between the wearable device 300 and the external object, such as a depth sensor and/or a time of flight (ToF) sensor. The camera 340 disposed toward the FoV may support an autofocus function and/or an optical image stabilization (OIS) function. For example, in order to obtain an image including a face of the user wearing the wearable device 300, the wearable device 300 may include the camera 340 (e.g., a face tracking (FT) camera) disposed toward the face.

Although not illustrated, the wearable device 300 according to an embodiment may further include a light source (e.g., LED) that emits light toward a subject (e.g., user's eyes, face, and/or an external object in the FoV) photographed using the camera 340. The light source may include an LED having an infrared wavelength. The light source may be disposed on at least one of the frame, and the hinge units 306 and 307.

According to an embodiment, the battery module 370 may supply power to electronic components of the wearable device 300. In an embodiment, the battery module 370 may be disposed in the first temple 304 and/or the second temple 305. For example, the battery module 370 may be a plurality of battery modules 370. The plurality of battery modules 370, respectively, may be disposed on each of the first temple 304 and the second temple 305. In an embodiment, the battery module 370 may be disposed at an end of the first temple 304 and/or the second temple 305.

According to an embodiment, the antenna module 375 may transmit the signal or power to the outside of the wearable device 300 or may receive the signal or power from the outside. The antenna module 375 may be electrically and/or operably connected to the communication circuit 250 of FIG. 2. In an embodiment, the antenna module 375 may be disposed in the first temple 304 and/or the second temple 305. For example, the antenna module 375 may be disposed close to one surface of the first temple 304 and/or the second temple 305.

According to an embodiment, speaker 392-1 and 392-2 may output a sound signal to the outside of the wearable device 300. A sound output module may be referred to as a speaker. In an embodiment, the speaker 392-1 and 392-2 may be disposed in the first temple 304 and/or the second temple 305 in order to be disposed adjacent to the car of the user wearing the wearable device 300. For example, the wearable device may include a second speaker 392-2 disposed adjacent to the user's left ear by being disposed in the first temple 304, and a first speaker 392-1 disposed adjacent to the user's right car by being disposed in the second temple 305.

According to an embodiment, a light emitting module (not illustrated) may include at least one light emitting element. The light emitting module may emit light of a color corresponding to a specific state or may emit light through an operation corresponding to the specific state in order to visually provide information on a specific state of the wearable device 300 to the user. For example, when the wearable device 300 requires charging, it may emit red light at a constant cycle. In an embodiment, the light emitting module may be disposed on the first rim 301 and/or the second rim 302.

Referring to FIG. 3B, according to an embodiment, the wearable device 300 may include the printed circuit board (PCB) 390. The PCB 390 may be included in at least one of the first temple 304 or the second temple 305. The PCB 390 may include an interposer disposed between at least two sub PCBs. On the PCB 390, one or more hardware included in the wearable device 300 may be disposed. The wearable device 300 may include a flexible PCB (FPCB) for interconnecting the hardware.

According to an embodiment, the wearable device 300 may include at least one of a gyro sensor, a gravity sensor, and/or an acceleration sensor for detecting the posture of the wearable device 300 and/or the posture of a body part (e.g., a head) of the user wearing the wearable device 300. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 300 may identify the user's motion and/or gesture performed to execute or stop a specific function of the wearable device 300 based on the IMU.

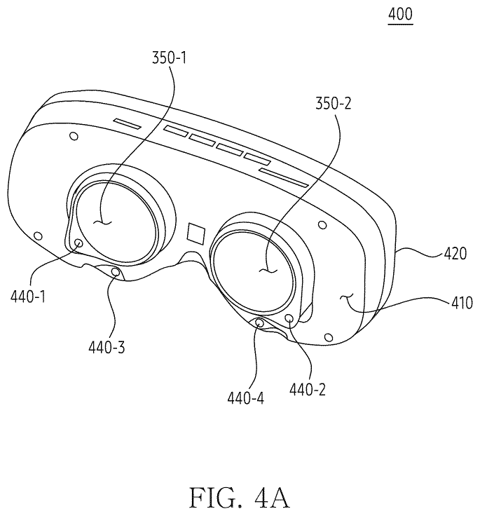

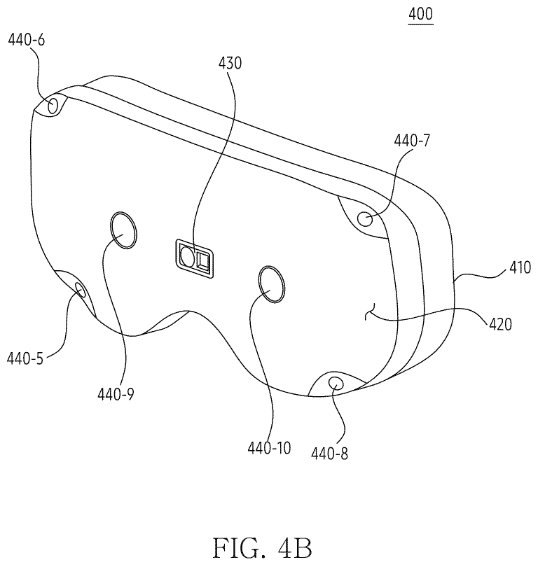

FIGS. 4A and 4B illustrate an exterior of an example wearable device 400 according to various embodiments. The wearable device 400 of FIGS. 4A and 4B may include a first terminal 120-1 of FIGS. 1 and 2. According to an embodiment, an example of an exterior of a first surface 410 of a housing of the wearable device 400 is illustrated in FIG. 4A, and an example of an exterior of a second surface 420 opposite to the first surface 410 may be illustrated in FIG. 4B.

Referring to FIG. 4A, according to an embodiment, the first surface 410 of the wearable device 400 may have an attachable shape on the user's body part (e.g., the user's face). Although not illustrated, the wearable device 400 may further include a strap for being fixed on the user's body part, and/or one or more temples (e.g., the first temple 304 and/or the second temple 305 of FIGS. 3A to 3B). A first display 350-1 for outputting an image to the left eye among the user's two eyes and a second display 350-2 for outputting an image to the right eye among the user's two eyes may be disposed on the first surface 410. The wearable device 400 may further include rubber or silicon packing, which are formed on the first surface 410, for preventing interference by light (e.g., ambient light) different from the light emitted from the first display 350-1 and the second display 350-2.

According to an embodiment, the wearable device 400 may include cameras 440-1 and 440-2 for photographing and/or tracking two eyes of the user adjacent to each of the first display 350-1 and the second display 350-2. The cameras 440-1 and 440-2 may be referred to, for example, as the ET camera. According to an embodiment, the wearable device 400 may include cameras 440-3 and 440-4 for photographing and/or recognizing the user's face. The cameras 440-3 and 440-4 may be referred to, for example, as a FT camera.

Referring to FIG. 4B, a camera (e.g., cameras 440-5, 440-6, 440-7, 440-8, 440-9, and 440-10), and/or a sensor (e.g., the depth sensor 430) for obtaining information associated with the external environment of the wearable device 400 may be disposed on the second surface 420 opposite to the first surface 410 of FIG. 4A. For example, the cameras 440-5, 440-6, 440-7, 440-8, 440-9, and 440-10 may be disposed on the second surface 420 in order to recognize an external object different from the wearable device 400. For example, by using cameras 440-9 and 440-10, the wearable device 400 may obtain an image and/or video to be transmitted to each of the user's two eyes. The camera 440-9 may be disposed on the second surface 420 of the wearable device 400 to obtain an image to be displayed through the second display 350-2 corresponding to the right eye among the two eyes. The camera 440-10 may be disposed on the second surface 420 of the wearable device 400 to obtain an image to be displayed through the first display 350-1 corresponding to the left eye among the two eyes.

According to an embodiment, the wearable device 400 may include the depth sensor 430 disposed on the second surface 420 in order to identify a distance between the wearable device 400 and the external object. By using the depth sensor 430, the wearable device 400 may obtain spatial information (e.g., a depth map) about at least a portion of the FoV of the user wearing the wearable device 400.

Although not illustrated, a microphone for obtaining sound outputted from the external object may be disposed on the second surface 420 of the wearable device 400. The number of microphones may be one or more according to various embodiments.

As described above, according to an embodiment, the wearable device 400 may have a form factor for being worn on the user's head. The wearable device 400 may provide a user experience based on augmented reality, virtual reality, and/or mixed reality within a state worn on the head. By using the cameras 440-5, 440-6, 440-7, 440-8, 440-8, 440-9, and 440-10 for recording a video for an external space, the wearable device 400 and a server (e.g., the server 110 of FIG. 1) connected to the wearable device 400 may provide an on-demand service, and/or a metaverse service that provides a video of a location and/or a place selected by a user.

According to an embodiment, the wearable device 400 may display frames obtained through the cameras 440-9 and 440-10 on the first display 350-1 and the second display 350-2, respectively. The wearable device 400 may provide a user experience (e.g., video see-through (VST)) in which a real object and a virtual object are mixed to the user, by combining a virtual object within the frame that is displayed through the first display 350-1 and the second display 150-2 and includes a real object. The wearable device 400 may change the virtual object based on information obtained by the cameras 440-1, 440-2, 440-3, 440-4, 440-5, 440-6, 440-7, and 440-8 and/or the depth sensor 430. For example, in a case that the visual object corresponding to the real object and the virtual object are at least partially overlapped within the frame, the wearable device 400 may stop displaying the virtual object, based on detecting motion to interact with the real object. By stopping displaying the virtual object, the wearable device 400 may prevent the visibility of the real object from deteriorating as the visual object corresponding to the real object is occluded by the virtual object.

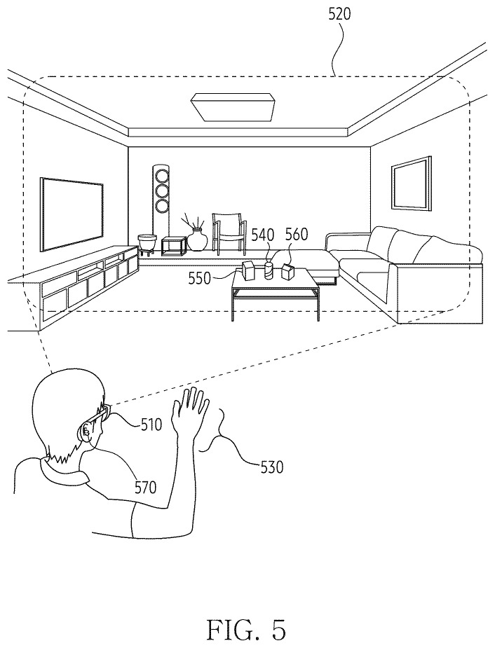

Hereinafter, with reference to FIG. 5, an example operation performed by an example wearable device (e.g., the first terminal 120-1 of FIG. 1 to FIG. 2) including the wearable device 300 of FIG. 3A and FIG. 3B and/or the wearable device 400 of FIG. 4A and FIG. 4B to adjust visibility of an external object based on a motion of a user with respect to the external object will be described.

FIG. 5 illustrates an example operation performed by a wearable device 510 based on data of a camera and/or a sensor, according to an embodiment. The wearable device 510 of FIG. 5 may include the first terminal 120-1 of FIG. 1 to FIG. 2, the wearable device 300 of FIG. 3A and FIG. 3B, and/or the wearable device 400 of FIG. 4A and FIG. 4B. For example, the wearable device 510 may include a head-mounted display (HMD) wearable on a head of a user.

According to an embodiment, the wearable device 510 may include a camera (e.g., the shooting camera 340-3 of FIG. 3B and/or the cameras 440-9 and 440-10 of FIG. 4B) disposed toward a front of the user, in a state in which the wearable device is attached to the user. The front of the user may include a direction in which the head of the user and/or two eyes included in the head face. In order to provide a user interface (UI) based on AR and/or MR to the user attaching the wearable device 510, the wearable device 510 may control the camera. The UI may be associated with a metaverse service provided by the wearable device 510 and/or a server (e.g., the server 110 of FIG. 1) connected to the wearable device 510.

Referring to FIG. 5, the wearable device 510 may display a visual object 560 in a field-of-view (FoV) 520 of the user using a display, in the state attached to the user. In the state, the wearable device 510 may form a display area in at least a portion of the FoV 520. The display area may include an area in the FoV 520 reachable by light emitted from the display. In a case that the wearable device 510 has a structure capable of passing through light (e.g., ambient light) directed to the two eyes of the user, such as the structure of FIG. 3A and FIG. 3B, the user may see the visual object 560 together with external objects 540 and 550. In a case that the wearable device 510 has a structure that blocks light, which faces to the two eyes of the user, such as the structure of FIG. 4A and FIG. 4B, the wearable device 510 may display frames outputted from the camera facing the front of the user in the FoV 520. The wearable device 510 may output light representing the visual object 560 together with light representing the external objects 540 and 550 to the user, by coupling the visual object 560 in the frames. In terms of absence with respect to a real space, the visual object 560 may be referred to, for example, as a virtual object. The external objects 540 and 550 may be referred to as real objects, in terms of existence with respect to the real space. One or more hardware included in the wearable device 510 will be described with reference to FIG. 6.

According to an embodiment, the wearable device 510 may display the visual object 560 in the FoV 520 based on execution of an application. The application may be installed in the wearable device 510 to provide a user experience based on AR and/or MR. The application installed in the wearable device 510 may include information for displaying the visual object 560. The information for displaying the visual object 560 may be referred to, for example, as object information in terms of information for displaying the virtual object in the FoV 520.

Referring to FIG. 5, in a state in which the application is executed, the wearable device 510 may display the visual object 560 based on object information provided together with the application. In a state in which the wearable device 510 is attached to the user, the visual object 560 displayed by the wearable device 510 may be viewed together with the external objects 540 and 550 included in the FoV 520 of the user. The object information matching the visual object 560 may include data indicating a size and/or a shape of the visual object 560. The object information matching the visual object 560 may include data for the wearable device 510 to render the object information. The data may be referred to as point cloud, vertex data, texture data, and/or shader. The object information may include data associated with deformation of the visual object 560

According to an embodiment, the wearable device 510 may change the visual object 560 based on a motion detected by the wearable device 510. The wearable device 510 may obtain sensor information indicating motion from the camera and/or a sensor disposed toward the FoV 520. The motion is a motion generated in a real space including the wearable device 510, and may include a motion of the user to which the wearable device 510 is attached. The motion may include a motion of an external object (e.g., the external objects 540 and 550) different from the user.

According to an embodiment, the wearable device 510 may identify whether the motion indicated by the sensor information corresponds to a preset motion in the object information matched to the visual object 560. Based on identifying the motion corresponding to the preset motion, the wearable device 510 may change the visual object 560. For example, the wearable device 510 may change the visual object 560 displayed in the FoV 520 based on the object information. Referring to FIG. 5, the wearable device 510 may identify a motion of a hand 530 indicated by the sensor information. The wearable device 510 may identify a position and/or the motion of the hand 530, from frames included in the sensor information.

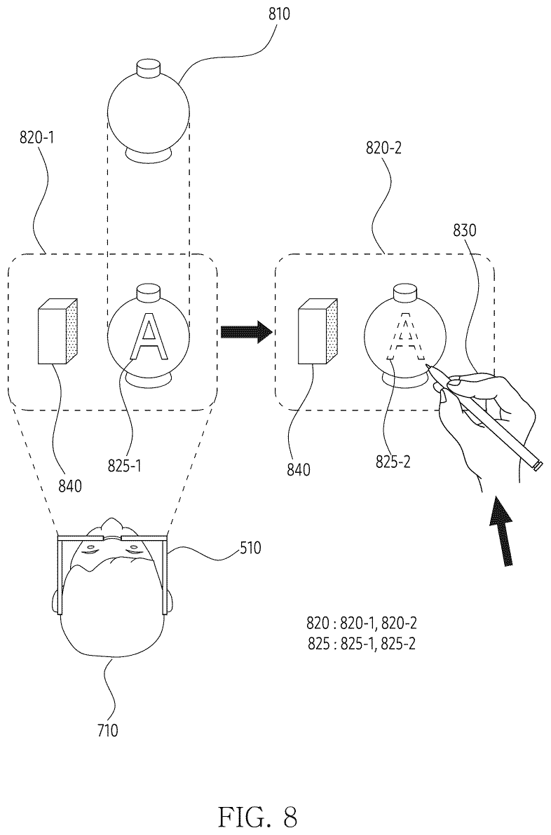

In an embodiment, in a case that the motion of the hand 530 indicated by the sensor information corresponds to a preset motion indicated by object information, the wearable device 510 may change the visual object 560 corresponding to the object information. Referring to FIG. 5, an example case in which the visual object 560 is displayed adjacent to the external object 540 in the FoV 520 is illustrated. In this case, in order to grab the external object 540, the user may extend the hand 530 toward the external object 540. The wearable device 510 may identify the hand 530 that moved toward the external object 540 adjacent to the visual object 560 from the sensor information. The wearable device 510 may determine whether to change the visual object 560, by comparing the motion of the hand 530 identified from the sensor information with the preset motion indicated by the object information. For example, in a case that the preset motion is a motion that extends the hand 530 to the external object 540 adjacent to the visual object 560, the wearable device 510 may change the visual object 560 displayed in the FoV 520. For example, in order to improve visibility of the external object 540 viewed through the FoV 520, the wearable device 510 may hide the visual object 560, increase a transparency (an opacity, or an alpha value) of the visual object 560, or apply a visual effect such as blur to the visual object 560. An example of an operation in which the wearable device 510 according to an embodiment changes the visual object 560 based on a motion of a body part (e.g., the hand 530) of the user to which the wearable device 510 is attached will be described with reference to FIG. 8.

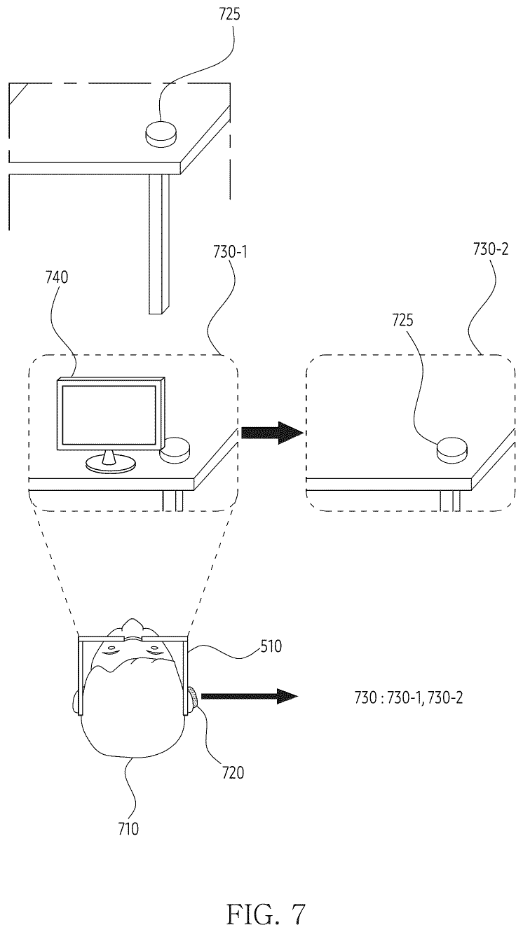

In an embodiment, the motion detected by the wearable device 510 based on the sensor information is not limited to a motion of an object directly linked to an intention of the user attaching the wearable device 510, such as the hand 530. The wearable device 510 may identify a motion of an external electronic device 570 different from the wearable device 510 from the sensor information. Referring to FIG. 5, as an example of the external electronic device 570, a wireless earphone that is attachable to an car of the user is illustrated. The wearable device 510 may identify the motion of the user associated with the external electronic device 570 based on the sensor information. In a case that the motion matches the preset motion indicated by the object information, the wearable device 510 may change the visual object 560 corresponding to the object information. An example of the operation in which the wearable device 510 changes the visual object 560 based on the motion for the external electronic device 570 will be described with reference to FIG. 7.

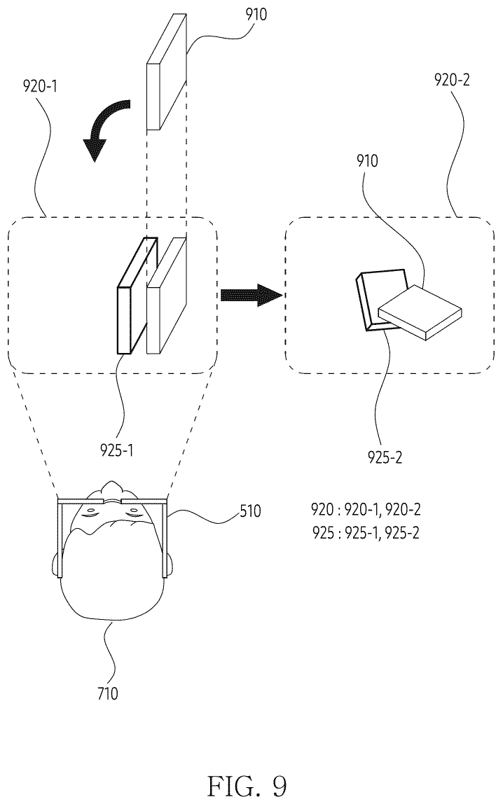

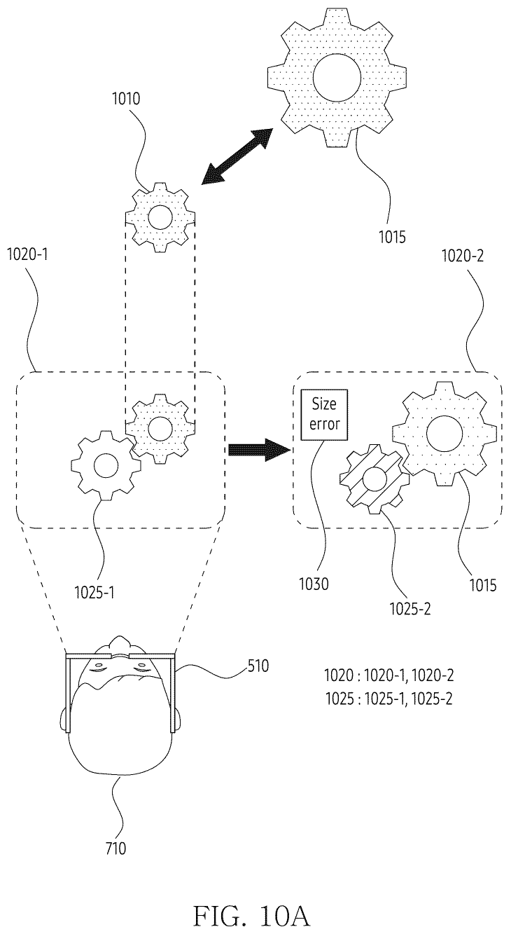

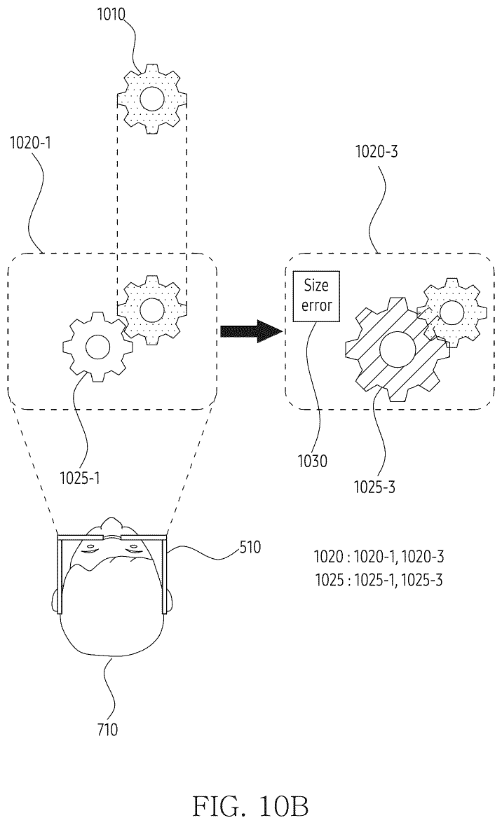

In an embodiment, the motion detected by the wearable device 510 based on the sensor information may include the motion of the external object (e.g., the external objects 540 and 550) distinguished from the user attaching the wearable device 510. In an example case in which the visual object 560 is linked to the external object 540 based on the object information, the wearable device 510 may change the visual object 560 based on the motion of the external object 540. For example, the wearable device 510 may change the visual object 560, in response to identifying that the motion of the external object 540 identified based on the sensor information corresponds to the preset motion indicated by the object information. An example of the operation in which the wearable device 510 changes the visual object 560 linked to the external object different from the body part (e.g., the hand 530) of the user will be described with reference to FIG. 9, FIG. 10A, and FIG. 10B. An embodiment is not limited thereto, and the wearable device 510 may, for example, change the visual object 560 based on a speech of the user.

As described above, the wearable device 510 according to an embodiment may change the visual object 560 based on motion generated in the real space including the wearable device 510. The wearable device 510 may change the shape, the size, and/or the transparency of the visual object 560 using the object information corresponding to the visual object 560. The wearable device 510 may identify a condition for changing the visual object 560 indicated by the object information. The condition may include the preset motion detected by the wearable device 510. For example, in response to identifying the preset motion based on the sensor information identified from the camera and/or the sensor of the wearable device 510, the wearable device 510 may render the visual object 560 based on a rendering function corresponding to the preset motion in the object information. Based on the change in the visual object 560, the wearable device 510 may conditionally improve visibility of the external object. Based on the change in the visual object 560, the wearable device 510 may enhance a relationship between the external object and the visual object 560. For example, the wearable device 510 may visualize the deformation of the visual object 560 due to the motion of the external object.

FIG. 6 illustrates a block diagram of a example wearable device 510, according to various embodiments. The wearable device 510 of FIG. 6 may include the first terminal 120-1 of FIG. 1 and FIG. 2, the wearable device 300 of FIG. 3A and FIG. 3B, the wearable device 400 of FIG. 4A and FIG. 4B, and/or the wearable device 510 of FIG. 5. The wearable device 510 may include at least one of a processor 610, memory 620, a display 630, a camera 640, or a sensor 650. The processor 610, the memory 620, the display 630, the camera 640, and the sensor 650 may be electronically and/or operably coupled with each other by an electronic component such as a communication bus 605. Hereinafter, hardware being operably coupled may refer to, for example, a direct connection, or an indirect connection, between the hardware which is established by wire or wirelessly so that second hardware is controlled by first hardware among the hardware. Although illustrated based on different blocks, the embodiment is not limited thereto, and a portion (e.g., at least a portion of the processor 610 and the memory 620) of the hardware of FIG. 6 may be included in a single integrated circuit such as a system on a chip (SoC). A type and/or the number of hardware included in the wearable device 510 is not limited as illustrated in FIG. 6. For example, the wearable device 510 may include only a portion of hardware components illustrated in FIG. 6.

The at least one processor 610 (including, e.g., processing circuitry) of the wearable device 510 according to an embodiment may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 610 may have a structure of a single-core processor, or may have a structure of a multi-core processor such as a dual core, a quad core, or a hexa core.

The memory 620 of the wearable device 510 according to an embodiment may include hardware for storing data and/or an instruction inputted and/or outputted to the processor 610 of the wearable device 510. The memory 620 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disc, a solid state drive (SSD), and an embedded multi media card (eMMC).

According to an embodiment, the display 630 of the wearable device 510 may output visualized information to a user. For example, the display 630 may be controlled by the processor 610 including a circuit such as a graphic processing unit (GPU), and then output the visualized information to the user. The display 630 may include a flat panel display (FPD) and/or electronic paper. The FPD may include a liquid crystal display (LCD), a plasma display panel (PDP), and/or one or more light emitting diodes (LEDs). The LED may include an organic LED (OLED). The display 630 of FIG. 6 may include the at least one display 350 of FIG. 3A and FIG. 3B and/or FIG. 4A and FIG. 4B.

According to an embodiment, the camera 640 of the wearable device 510 may include one or more optical sensors (e.g., a charged coupled device (CCD) sensor and a complementary metal oxide semiconductor (CMOS) sensor) for generating an electrical signal indicating a color and/or brightness of light. A plurality of optical sensors included in the camera 640 may be disposed in a shape of a 2 dimensional array. The camera 640 may generate a 2 dimensional frame corresponding to light reaching the optical sensors of the 2 dimensional array, by obtaining electrical signals of each of the plurality of optical sensors substantially simultaneously. For example, photo data captured using the camera 640 may include one 2 dimensional frame obtained from the camera 640. For example, video data captured using the camera 640 may refer, for example, to a sequence of a plurality of 2 dimensional frames obtained from the camera 640 according to a frame rate. The camera 640 may be disposed toward a direction in which the camera 640 receives light, and may further include flash light for outputting light toward the direction.

Although the camera 640 is illustrated based on a single block, the number of the cameras 640 included in the wearable device 510 is not limited to the embodiment. For example, the wearable device 510 may include one or more cameras, such as the one or more cameras 340 of FIG. 3A and FIG. 3B and/or FIG. 4A and FIG. 4B.

According to an embodiment, the sensor 650 of the wearable device 510 may generate electronic information that may be processed by the processor 610 and/or the memory 620 of the wearable device 510 from non-electronic information associated with the wearable device 510. For example, the sensor 650 may include a microphone for outputting a signal (e.g., an audio signal) including electronic information on a sound wave. For example, the sensor 650 may include an inertia measurement unit (IMU) for detecting a physical motion of the wearable device 510. The IMU may include an acceleration sensor, a gyro sensor, a geomagnetic sensor, or a combination thereof. The acceleration sensor may output data indicating a direction and/or magnitude of acceleration of gravity applied to the acceleration sensor along a plurality of axes (e.g., an x-axis, a y-axis, and a z-axis) perpendicular to each other. The gyro sensor may output data indicating rotation of each of the plurality of axes. The geomagnetic sensor may output data indicating a direction (e.g., a direction of an N pole or an S pole) of a magnetic field in which the geomagnetic sensor is included. The IMU in the sensor 650 may be referred to as a motion sensor in terms of detecting a motion of the wearable device 510. For example, the sensor 650 may include a proximity sensor and/or a grip sensor for identifying an external object contacted on a housing of the wearable device 510. The number and/or a type of the sensors 650 is not limited to those described above, and the sensor 650 may include, for example, an image sensor, an illumination sensor, a time-of-flight (ToF) sensor, and/or a global positioning system (GPS) sensor for detecting an electromagnetic wave including light.

Although not illustrated, the wearable device 510 according to an embodiment may include an output device (including, e.g., output circuitry) for outputting information in another shape other than a visualized shape. For example, the wearable device 510 may include a speaker (e.g., the speakers 392-1 and 392-2 of FIG. 3A and FIG. 3B) for outputting an acoustic signal. For example, the wearable device 510 may include a motor for providing haptic feedback based on vibration.

In the memory 620 of the wearable device 510 according to an embodiment, one or more instructions (or commands) indicating a calculation and/or an operation to be performed on data by the at least one processor 610 of the wearable device 510 may be stored. A set of one or more instructions may be referred to as firmware, an operating system, a process, a routine, a sub-routine, and/or an application. Hereinafter, the application being installed in the wearable device 510, which is one or more instructions provided in a shape of the application are stored in the memory 620, may refer to, for example, the one or more applications being stored in a format (e.g., a file having an extension preset by an operating system of the wearable device 510) executable by the processor 610.

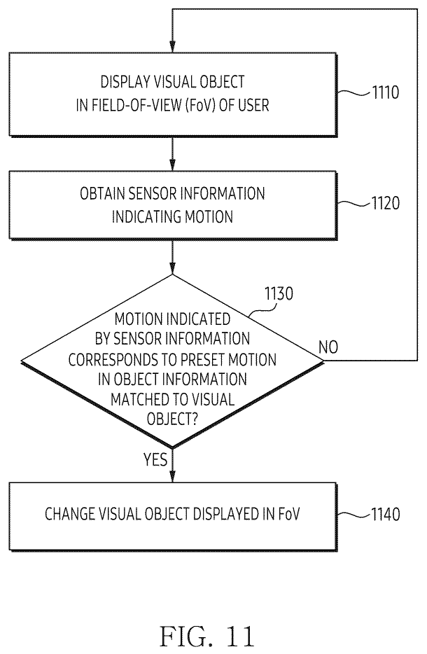

Referring to FIG. 6, instructions stored in the memory 620 of the wearable device 510 may be distinguished by a motion analyzer 660, a rendering controller 665, a renderer 680, and/or an application 675. While the instructions are executed, the processor 610 of the wearable device 510 may perform at least one of operations of FIG. 11 to FIG. 13. The instructions may be executed by the processor 610 to change a method of rendering a visual object (e.g., the visual object 560 of FIG. 5) displayed through the display 630 based on a motion detected by the wearable device 510. Object information 670 provided together with the application 675 may be stored in the memory 620. According to an embodiment, the wearable device 510 may change the visual object (e.g., the visual object 560 of FIG. 5) included in a display area of the display 630 based on the motion detected by the wearable device 510 based on the motion analyzer 660, the rendering controller 665, the object information 670, the application 675, and/or the renderer 680.

The at least one processor 610 of the wearable device 510 according to an embodiment may analyze the motion detected by the wearable device 510 using sensor information, in a state in which the motion analyzer 660 is executed. The sensor information may include frames outputted from the camera 640 and/or sensor data outputted from the sensor 650. Based on the execution of the motion analyzer 660, the processor 610 may identify an intention of the user for interacting with an augmented reality environment provided to the user through the wearable device 510.

The processor 610 of the wearable device 510 according to an embodiment may obtain sensor information associated with a motion of the user based on an input interface for obtaining a user input, in the state in which the motion analyzer 660 is executed. The input interface is an interface between the wearable device 510 and a user to which the wearable device 510 is attached, and may include, for example, the camera 640 of FIG. 6 and/or the motion sensor. An embodiment is not limited thereto, and the input interface may include hardware for identifying a speech of the user to which the wearable device 510 is attached, such as a microphone. Based on the sensor information obtained using the input interface, the processor 610 may identify, track, and/or monitor motions of different body parts (e.g., a hand, an upper body, and/or a lower body) of the user.

The processor 610 according to an embodiment may identify a motion of a preset body part (e.g., the hand 530 of FIG. 5) based on the sensor information in the state in which the motion analyzer 660 is executed. Identifying the motion of the preset body part by the processor 610 may include an operation of identifying a subject (e.g., the user) of the motion and a category of the motion (e.g., an extending hand action, a sitting action, and a walking action). The categories may be distinguished according to an intention of the user to grab or touch an external object, or an intention of the user to move the external object. For example, the processor 610 may identify a contact between the external object and a body part based on the sensor information.

In an embodiment, the processor 610 may obtain the sensor information from the sensor 650 in the wearable device 510 based on execution of the motion analyzer 660. The processor 610 may obtain the sensor information from an external electronic device (e.g., a keyboard, a mouse, a wireless earphone, and/or a grabbable controller) connected to the wearable device 510. In a state in which the motion analyzer 660 is executed, the processor 610 may identify an interaction between the body part and the external object occurring in a real space including the wearable device 510 from a motion indicated by the sensor information.

The processor 610 according to an embodiment may change a method of displaying a virtual object (e.g., the visual object 560 of FIG. 6) based on a motion identified using the motion analyzer 660 based on execution of the rendering controller 665. The processor 610 may display a visual object (e.g., the visual object 560 of FIG. 6) corresponding to the virtual object through the display 630. In a state in which the rendering controller 665 is executed, the processor 610 may identify one or more virtual objects to be displayed through the display 630 based on the object information 670. In a state in which the rendering controller 665 is executed, the processor 610 may compare the motion identified from the sensor information with a preset motion indicated by the object information 670, using the motion analyzer 660. The object information 670 may include first data indicating the preset motion, and second data matching the first data and indicating a rendering function of the virtual object.

The processor 610 according to an embodiment may identify whether the motion identified based on the motion analyzer 660 matches the preset motion for changing the rendering function to be applied to the virtual object, in a state in which the rendering controller 665 is executed. For example, the preset motion may include an action of the user touching an external object. For example, the preset motion may include a motion of the external object, which is identified from the frames of the camera 640 and different from the body part of the user. In a case that the motion identified using the motion analyzer 660 matches the preset motion, the processor 610 may determine to change the rendering function of the virtual object corresponding to the preset motion.

According to an embodiment, the processor 610 may select and/or determine the rendering function of the virtual object associated with the motion identified from the sensor information in a state in which the rendering controller 665 is executed. For example, the processor 610 may change the rendering function based on the intention of the user included in the motion.

In a case of identifying a motion of the user for moving the external object, the processor 610 may change the rendering function and/or a display mode of the virtual object overlapped to the external object or adjacent to the external object based on the execution of the rendering controller 665. For example, based on a motion of one or more external objects moved by an action of the user, the processor 610 may change the rendering function and/or the display mode of the virtual object linked to the one or more external objects. For example, the processor 610 may predict the motion of the virtual object based on the motion of the one or more external objects. Based on a result of predicting the motion of the virtual object, the processor 610 may change the rendering function and/or the display mode of the virtual object. For example, based on the motion of the external object being moved and/or rotated by the action of the user, the processor 610 may change the virtual object linked to the external object. Based on the movement and/or the rotation of the external object, the processor 610 may move and/or rotate the virtual object. The processor 610 changing the display mode of the virtual object may include an operation of hiding the virtual object or ceasing display of the virtual object.

As described above, according to an embodiment, the processor 610 changing the display of the virtual object may be performed based on the object information 670. The object information 670 may include data used to render the virtual object in the display 630. The object information 670 may include, for example, data indicating the preset motion used to identify whether to change the display of the virtual object. For example, in a case that the preset motion is the motion of the preset body part (e.g., the hand 530 of FIG. 5), the data included in the object information 670 may indicate a position, a direction, and/or a path of the preset body part. The object information 670 may include data indicating the rendering function of the virtual object matching the preset motion. The data included in the object information 670 may indicate a shape, a color, a size, a position, and/or rotation of the virtual object. The data may be loaded into the processor 610, based on execution of the renderer 680 and/or the application 675. Based on the loaded data, the processor 610 may render the virtual object in the display 630.

In case of determining to change the rendering function of the virtual object using the rendering controller 665, the at least one processor 610 according to an embodiment may render the virtual object based on the changed rendering function by executing the renderer 680 and/or the application 675 corresponding to the virtual object. The application 675 installed in the wearable device 510 may be executed by the processor 610 to display the virtual object. The renderer 680 may be executed by the processor 610 to render the virtual object. For example, based on a preset application programming interface (API) called by the application 675, the processor 610 may render one or more virtual objects provided by the application 675, by executing the renderer 680. In a state of rendering the one or more virtual objects, the processor 610 may apply the rendering function identified by the rendering controller 665. The renderer 680 may render the one or more virtual objects to be displayed through the display 630, by controlling, for example, a GPU in the processor 610 based on the rendering function.

As described above, according to an embodiment, the wearable device 510 may change at least one virtual object rendered in the display 630 in response to identifying the preset motion indicated by the object information 670. For example, the wearable device 510 may adaptively change the at least one virtual object based on the preset motion. Hereinafter, an example of an operation in which the wearable device 510 according to an embodiment changes the display mode (e.g., whether to display the visual object corresponding to the virtual object) of the virtual object based on the sensor information will be described with reference to FIG. 7.

FIG. 7 illustrates an example operation performed by an example wearable device 510 based on a state of an external electronic device identified through a sensor, according to various embodiments. The wearable device 510 of FIG. 7 may be an example of the wearable device 510 of FIG. 5 and FIG. 6.

Referring to FIG. 7, an example case in which a user 710 simultaneously uses a plurality of electronic devices is illustrated. For example, the user 710 may attach the wearable device 510 and a first external electronic device 720, which is a wireless earphone. A second external electronic device 725 may be a wireless earphone case linked to the first external electronic device 720, which is the wireless earphone, for charging the first external electronic device 720. The wearable device 510 may identify the first external electronic device 720 attached to the user 710 using sensor information. Although a single wireless earphone is illustrated, an embodiment is not limited thereto.

Referring to FIG. 7, in a FoV 730-1 of a first state, the wearable device 510 may display a visual object 740. The visual object 740 may correspond to a virtual object of an application executed by the wearable device 510. In a case that the application is installed in the wearable device 510 to display a virtual display, the wearable device 510 may provide a user experience based on the virtual display in the FoV 730-1 of the first state by executing the application. For example, through the visual object 740 having a shape of a monitor, the wearable device 510 may display a screen provided from the application. In the FoV 730-1 of the first state, it is assumed that the wearable device 510 displays the visual object 740 at a position partially overlapped with the second external electronic device 725. A shape, a position, and/or a size of the visual object 740 displayed in the FoV 730-1 of the first state may be set by object information (e.g., the object information 670 of FIG. 6).

According to an embodiment, the wearable device 510 may identify a state of the first external electronic device 720 connected to the wearable device 510 using the sensor information. The state of the first external electronic device 720 may be changed by a motion associated with the first external electronic device 720. For example, based on the change in the state, the wearable device 510 may change the visual object 740. For example, in a case that the first external electronic device 720 attached to the user 710 is separated from the user 710, the wearable device 510 may identify the state of the first external electronic device 720 separated from the user 710 and/or a motion of the first external electronic device 720 separated from the user 710 using the sensor information. The wearable device 510 may identify the motion for the first external electronic device 720 based on execution of the motion analyzer 660 of FIG. 6.

According to an embodiment, the wearable device 510 may identify whether the motion of the first external electronic device 720 identified by the sensor information corresponds to a preset motion indicated by object information associated with the visual object 740. For example, in a case that the motion of the first external electronic device 720 separated from the user 710 corresponds to a preset motion indicated by the object information, the wearable device 510 may change the visual object 740 based on a rendering function and/or a display mode matched to the preset motion in the object information. The rendering function and/or the display mode indicated by the object information may be associated with an external object (e.g., the second external electronic device 725) displayed adjacent to the visual object 740.

For example, the motion of separating the first external electronic device 720, which is the wireless earphone, from the user 710 may indicate that a probability of a motion occurring for the second external electronic device 725 associated with the first external electronic device 720 increases. For example, the user 710 may separate the first external electronic device 720 from the user 710, in order to couple the first external electronic device 720 with the second external electronic device 725, which is the wireless earphone case. In the example, the wearable device 510 may change the rendering function and/or the display mode of the visual object 740 based on whether the second external electronic device 725 is included in a FoV 730 and/or whether the second external electronic device 725 is occluded by the visual object 740.

In an embodiment, the wearable device 510 may identify the second external electronic device 725 from frames of a camera (e.g., the camera 640 of FIG. 6) based on identifying the preset motion (e.g., the motion separating the first external electronic device 720 from the user 710) associated with the first external electronic device 720. The wearable device 510 may identify a location of the second external electronic device 725 in the frames. In the FoV 730-1 of the first state, the wearable device 510 may identify that the second external electronic device 725 is disposed at the position occluded by the visual object 740. The wearable device 510 may determine to change the rendering function and/or the display mode of the visual object 740 overlapped to the second external electronic device 725 using object information corresponding to the visual object 740. A FoV 730-2 of a second state may correspond to a state in which the wearable device 510 changes the visual object 740 based on the determination.

Referring to FIG. 7, in the FoV 730-2 of the second state, the wearable device 510 may at least temporarily cease displaying the visual object 740 by changing the display mode of the visual object 740 overlapped to the second external electronic device 725. For example, based on identifying the second external electronic device 725 occluded by the visual object 740 in the FoV 730, the wearable device 510 may cease displaying the visual object 740 or change a transparency of the visual object 740 based on the object information. In a case that a plurality of visual objects including the visual object 740 are displayed, the wearable device 510 may selectively change a visual object (e.g., the visual object 740) overlapped with the second external electronic device 725.

For example, the wearable device 510 may improve visibility of the second external electronic device 725 occluded by the visual object 740 based on a preset transparency indicated by the object information. For example, the wearable device 510 may improve the visibility of the second external electronic device 725 by applying a visual effect (e.g., blur) indicated by the object information to the visual object 740. For example, the wearable device 510 may display the location of the second external electronic device 725 in the FoV 730, by displaying another visual object for emphasizing the second external electronic device 725 occluded by the visual object 740. The other visual object may have a shape of an outline of the second external electronic device 725 viewed through the FoV 730. An operation performed by the wearable device 510 to emphasize the second external electronic device 725 is not limited to these examples. For example, the wearable device 510 may emphasize the second external electronic device 725 by changing a position and/or a size of the other visual object displayed in the FoV 730.

As described above, the wearable device 510 according to an embodiment may identify a motion for any one of a plurality of external electronic devices (e.g., the first external electronic device 720 and the second external electronic device 725) linked to each other using the sensor information. Based on the motion, the wearable device 510 may perform an operation for improving visibility of another one of the plurality of external electronic devices. For example, based on identifying a motion for the first external electronic device 720, the wearable device 510 may change the rendering function and/or the display mode of at least one visual object (e.g., the visual object 740) that occludes the second external electronic device 725 linked to the first external electronic device 720 in the FoV 730.

Hereinafter, an example operation performed by the wearable device 510 based on the motion detected by the sensor information, according to various embodiments will be described with reference to FIG. 8.

FIG. 8 illustrates an example operation performed by an example wearable device 510 based on a motion of a user 710, according to various embodiments. The wearable device 510 of FIG. 8 may be an example of the wearable device 510 of FIG. 5 and FIG. 6.

Referring to FIG. 8, based on execution of an application (e.g., the application 675 of FIG. 6), the wearable device 510 may display visual objects 825 and 840. In a state in which the wearable device is attached to the user 710, the wearable device 510 may display a plurality of visual objects 825 and 840 in a FoV 820 of the user 710 using a display (e.g., the display 630 of FIG. 6). The wearable device 510 may render the plurality of visual objects 825 and 840 based on object information provided from the application. Referring to a FoV 820-1 of a first state, the wearable device 510 may render a visual object 825-1 based on the first state indicated by the object information as overlapping with an external object 810. In the FoV 820-1 of the first state, the wearable device 510 may perform a simulation for the external object 810 using the visual object 825-1 displayed on a position where the external object 810 is viewed.

According to an embodiment, the wearable device 510 may detect a motion based on sensor information obtained from a camera (e.g., the camera 640 of FIG. 6) and/or a sensor (e.g., the sensor 650 of FIG. 6). For example, the wearable device 510 may identify a hand 830 approaching toward the external object 810 based on frames obtained from the camera. The wearable device 510 may identify the hand 830 contacted on the external object 810 using the sensor information. For example, the user 710 may move the hand 830 toward the external object 810 to draw a picture based on the visual object 825 displayed as overlapping on the external object 810 in the FoV 820. According to an embodiment, the wearable device 510 may change the visual object 825 overlapped with the external object 810 and/or the hand 830 in the FoV 820 based on identifying a motion of the hand 830 contacted on the external object 810.

Referring to a FoV 820-2 of a second state of FIG. 8, based on detecting a motion of the hand 830 contacted on the external object 810, the wearable device 510 may render a visual object 825-2 based on a rendering function corresponding to the detected motion in object information corresponding to the visual object 825. Referring to the visual objects 840 and 825-2 displayed in the FoV 820-2 of the second state, the wearable device 510 may maintain a state of the visual object 840 independently of the motion of the hand 830. Since the wearable device 510 changes the rendering function of the visual object 825 based on the motion of the hand 830, the visual object 825-2 in the FoV 820-2 of the second state may have a color and/or a transparency different from the visual object 825-1 in the FoV 820-1 of the first state. For example, the wearable device 510 may improve visibility of the external object 810 overlapped with the visual object 825, by increasing a transparency of the visual object 825. Based on the improved visibility, the user 710 may more accurately recognize an interaction between the external object 810 and the hand 830. Based on identifying that the contact of the external object 810 and the hand 830 is released, the wearable device 510 may restore a state of the visual object 825-2 to a state before identifying the contact between the external object 810 and the hand 830.

As described above, while displaying the different visual objects 825 and 840, the wearable device 510 according to an embodiment may change at least one of the visual objects 825 and 840 based on a motion (e.g., the motion of the hand 830) generated in an outer space of the wearable device 510. The wearable device 510 changing at least one of the visual objects 825 and 840 may be performed based on object information corresponding to the visual objects 825 and 840. Since at least one of the visual objects 825 and 840 is changed based on the object information, the wearable device 510 may adaptively change at least one of the visual objects 825 and 840 using a rendering function corresponding to the motion.

An embodiment is not limited thereto, and the wearable device 510 may change at least one of the visual objects 825 and 840 based on a speech of the user 710 identified through a microphone while displaying the visual objects 825 and 840. For example, the wearable device 510 may identify the speech from an audio signal outputted from the microphone. For example, the wearable device 510 may identify the speech including a natural language sentence (e.g., “I want to see ceramics”) including a name of the external object 810. Based on the speech, the wearable device 510 may change the visual object 825 displayed as overlapping the external object 810. The wearable device 510 changing the visual object 825 may be performed based on the object information corresponding to the visual object 825.

In an embodiment, the motion detected by the wearable device 510 is not limited to the motion of the user, and may include a motion of an external object (e.g., the external object 810) different from the user. Hereinafter, an example operation performed by the wearable device 510 based on the motion of the external object, according to an embodiment will be described with reference to FIG. 9.

FIG. 9 illustrates an example operation performed by a wearable device 510 based on an external object 910, according to various embodiments. The wearable device 510 of FIG. 9 may be an example of the wearable device 510 of FIG. 5 and FIG. 6.

Referring to FIG. 9, based on execution of an application (e.g., the application 675 of FIG. 6), the wearable device 510 may display a visual object 925 linked to an external object 910. The wearable device 510 may identify the external object 910 linked to the visual object 925 based on object information corresponding to the visual object 925. Based on a position relationship between the external object 910 and a virtual object in a 3-dimensional coordinate system indicated by the object information, the wearable device 510 may display the visual object 925 representing the virtual object. In a state of a user 710 attaching the wearable device 510, the wearable device 510 may display the visual object 925 in linkage with the external object 910 viewed through a FoV 920. Referring to a FoV 920-1 of a first state, a visual object 925-1 rendered by the position relationship may be at least partially occluded by the external object 910.

In an embodiment, in a state of displaying the visual object 925 in linkage with the external object 910, the wearable device 510 may identify whether a motion of the external object 910 occurs or changes based on sensor information obtained from a camera (e.g., the camera 640 of FIG. 6) and/or a sensor (e.g., the sensor 650 of FIG. 6). Based on identifying the external object 910 changed by a motion, the wearable device 510 may change the visual object 925 linked to the external object 910. The wearable device 510 may change the visual object 925 based on at least one of a position or a shape of the external object 910 changed by the motion. The wearable device 510 may identify at least one of the position or the shape of the external object 910 linked to the visual object 925 based on frames outputted from the camera.

Referring to FIG. 9, based on identifying the motion of the external object 910 linked to the visual object 925, the wearable device 510 may change the visual object 925. Referring to a FoV 920-2 of a second state, the wearable device 510 may identify a falling motion of the external object 910 from frames including at least a portion of the FoV 920-2 of the second state. Based on identifying the motion, the wearable device 510 may change a visual object 925-2 displayed in the FoV 920-2 of the second state, based on the motion of the external object 910. For example, the wearable device 510 may display an animation of the visual object 925-2 falling by the external object 910 in the FoV 920-2.

In an embodiment, the wearable device 510 may display the visual object 925 in the FoV 920, based on object information provided from an application for providing a domino game based on augmented reality. For example, in a case that the visual object 925 is displayed in linkage with the external object 910 corresponding to a block of the domino, the wearable device 510 may detect and/or predict the motion of the external object 910 based on whether a specific block falls in a sequence of blocks including the external object 910. Based on a result of detecting and/or predicting the motion of the external object 910, the wearable device 510 may change the visual object 925 displayed in the FoV 920 and linked to the external object 910.

Hereinafter, an example UI displayed by the wearable device 510 based on an interaction between the external object 910 and the visual object 925, according to various embodiments, will be described with reference to FIG. 10A and FIG. 10B.

FIG. 10A and FIG. 10B illustrate an example operation of displaying a visual object linked to an external object by a wearable device according to various embodiments. The wearable device 510 of FIG. 10A and FIG. 10B may be an example of the wearable device 510 of FIG. 5 and FIG. 6.

Referring to FIG. 10A and FIG. 10B, the wearable device 510 may display a visual object 1025 in a FoV 1020 based on object information provided from an application. The wearable device 510 may display the visual object 1025 in linkage with an external object 1010 indicated by the object information. According to an embodiment, the wearable device 510 may identify a position relationship between the visual object 1025 and the external object 1010 linked to the visual object 1025 based on frames outputted from a camera (e.g., the camera 640 of FIG. 6). Based on the position relationship, the wearable device 510 may change a shape, a position, and/or a size of the visual object 1025 in the FoV 1020. Referring to a FoV 1020-1 of a first state of FIG. 10A, the wearable device 510 may display a visual object 1025-1 in linkage with the external object 1010 viewed through the FoV 1020-1 of the first state based on the position relationship.

According to an embodiment, the wearable device 510 may identify a motion of the external object 1010 for changing the visual object 1025 based on a position and/or a size of the external object 1010 in the FoV 1020, obtained from sensor information and linked to the visual object 1025. For example, the wearable device 510 may compare the position relationship between the external object 1010 and the visual object 1025 and the object information to identify whether the motion corresponds to a preset motion indicated by the object information.

Referring to FIG. 10A, the wearable device 510 may identify a motion to replace the external object 1010 linked to the visual object 1025 with an external object 1015 larger than the external object 1010. Referring to a FoV 1020-2 of a second state of FIG. 10A, based on detecting the motion of replacing the external object 1010 with the external object 1015, the wearable device 510 may change a color and/or a shape of a visual object 1025-2. For example, the visual object 1025-2 may have a preset color (e.g., red) indicated by the motion in the object information. The preset color of the visual object 1025-2 may be different from a color of the visual object 1025-1 before detecting the motion. In the FoV 1020-2 of the second state, the wearable device 510 may display a visual object 1030 in a shape of a pop-up window for guiding that the visual object 1025-2 is not linked to the external object 1015 by the motion. The visual object 1025-2 not being linked to the external object 1015 may refer, for example, to a preset condition for linking and displaying the visual object 1025-2 and the external object 1015 indicated by the object information 670 of FIG. 6 not being satisfied. In the visual object 1030, the wearable device 510 may display preset text for guiding a position relationship between the external object 1015 and the visual object 1025-2. The wearable device 510 may display the preset text based on the object information 670 of FIG. 6. Referring to FIG. 10A, the preset text may include text for guiding a reason why the visual object 1025-2 may not be displayed in linkage with the external object 1015, such as “size error”.

In an embodiment, an operation of the wearable device 510 based on a motion of a real object (e.g., the external object 1010) has been described, but an embodiment is not limited thereto. For example, the wearable device 510 may identify an input indicating to change the visual object 1025 displayed in the FoV 1020. Based on the input, in a state in which the visual object 1025 is changed, the wearable device 510 may change a rendering function of the visual object 1025 based on the position relationship between the visual object 1025 and the external object 1010 indicated by the object information.

Referring to FIG. 10B, in the FoV 1020-1 of the first state, the wearable device 510 may identify a motion indicating to change a size of the visual object 1025-1. The motion may include a speech of a user 710, a motion touching a button and/or a housing of the wearable device 510, and/or a motion (e.g., movement of a hand of the user 710) of the user 710 performed in the FoV 1020-1. Referring to a FoV 1020-3 of a third state of FIG. 10B, based on the motion, the wearable device 510 may enlarge and display a visual object 1025-3. The wearable device 510 may compare the motion indicating to enlarge the visual object 1025-3 with a preset motion indicated by the object information and set to change the rendering function of the visual object 1025-3. In a case that the motion indicating to enlarge the visual object 1025-3 substantially matches the preset motion, the wearable device 510 may apply the rendering function corresponding to the preset motion to the visual object 1025-3.

Referring to FIG. 10B, in the FoV 1020-3 of the third state, the wearable device 510 may identify that the visual object 1025-3 enlarged by the motion is not linked to the external object 1010. The wearable device 510 identifying that the visual object 1025-3 may not be displayed in linkage with the external object 1010 may change a color of the visual object 1025-3 to a preset color indicated by the object information. Together with the visual object 1025-3 having the preset color, the wearable device 510 may display the visual object 1030 for guiding that the visual object 1025-3 may not be displayed in linkage with the external object 1010. For example, a preset motion for changing a color of the visual object 1025 to the preset color and indicated by the object information may include a motion that enlarges the size of the visual object 1025 beyond a preset range capable of being displayed in linkage with the external object 1010.

As described above, the wearable device 510 according to an embodiment may render the visual object 1025 based on a motion changing a linkage between the visual object 1025 and the external object 1010. Since the linkage set by the object information is used for rendering the visual object 1025, the wearable device 510 may enhance a user experience associated with the external object 1010 and based on augmented reality.

FIG. 11 illustrates a flowchart of an example wearable device according to various embodiments. The wearable device of FIG. 11 may be an example of the wearable device 510 of FIG. 5 and FIG. 6. At least one of operations of FIG. 11 may be performed by the wearable device 510 of FIG. 6 and/or the processor 610 of FIG. 6. In the following embodiment, each of the operations may be sequentially performed, but is not necessarily performed sequentially. For example, an order of each of the operations may be changed, and/or at least two operations may be performed in parallel.

Referring to FIG. 11, in an operation 1110, the wearable device according to an embodiment may display a visual object in a FoV of a user. In a state in which an application is executed, the wearable device may display the visual object based on object information provided from the application.

Referring to FIG. 11, in an operation 1120, the wearable device according to an embodiment may obtain sensor information indicating a motion. The wearable device may obtain the sensor information using a camera (e.g., the camera 640 of FIG. 6) and/or a sensor (e.g., the sensor 650 of FIG. 6). The sensor information may include data indicating a motion of the wearable device. The sensor information may include data indicating a motion of a user to which the wearable device is attached. The sensor information may include data indicating a motion of one or more external objects included in a real space including the wearable device.

Referring to FIG. 11, in an operation 1130, the wearable device according to an embodiment may determine whether the motion indicated by the sensor information corresponds to a preset motion in object information matched to the visual object. The preset motion may be a condition for changing a shape, a color, a size, a rendering function, and/or a display mode of the visual object. As described above with reference to FIG. 7, the preset motion may include the motion of the user for an external electronic device different from the wearable device. As described above with reference to FIG. 8, the preset motion may include the motion of the user for interacting with the external object. As described above with reference to FIG. 9, FIG. 10A, and FIG. 10B, the preset motion may include the motion of the external object linked to the visual object. In a state in which a motion different from the preset motion is identified from the sensor information (1130—NO), the wearable device may maintain the display of the visual object and the obtainment of the sensor information based on the operations 1110 and 1120.

In a state in which a motion corresponding to the preset motion is identified from the sensor information (1130—YES), the wearable device may change the visual object displayed in the FoV, based on an operation 1140. The wearable device may change the visual object by applying the rendering function corresponding to the preset motion in the object information to the visual object. For example, in a case that the object information indicates to cease the display of the visual object based on the identification of the preset motion, the wearable device may hide the visual object displayed in the FoV. For example, in a case that the object information indicates to change a transparency of the visual object based on the identification of the preset motion, in the operation 1140, the wearable device may change the transparency of the visual object displayed in the FoV.

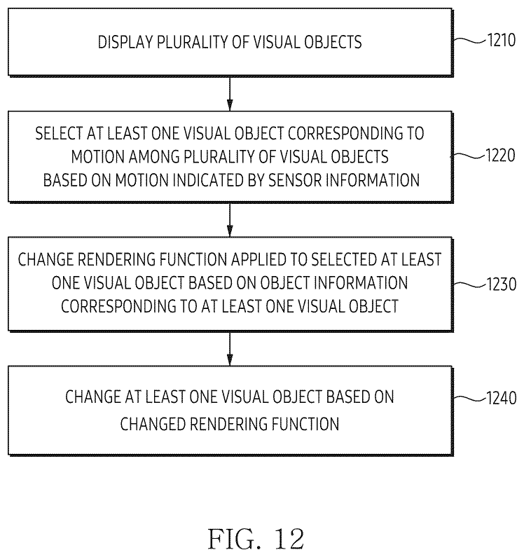

FIG. 12 illustrates a flowchart of a wearable device according to various embodiments. The wearable device of FIG. 12 may be an example of the wearable device 510 of FIG. 5 and FIG. 6. At least one of operations of FIG. 12 may be performed by the wearable device 510 of FIG. 6 and/or the processor 610 of FIG. 6. At least one of the operations of FIG. 12 may be associated with at least one of the operations of FIG. 11. In the following embodiment, each of the operations may be sequentially performed, but is not necessarily performed sequentially. For example, an order of each of the operations may be changed, and/or at least two operations may be performed in parallel.

Referring to FIG. 12, in an operation 1210, the wearable device according to an embodiment may display a plurality of visual objects. The plurality of visual objects may be displayed based on one or more applications executed by the wearable device. In a state in which the wearable is attached to a user, the wearable device may display the plurality of visual objects in a FoV of the user. The wearable device may display the plurality of visual objects based on object information.

Referring to FIG. 12, in an operation 1220, based on a motion indicated by sensor information, the wearable device according to an embodiment may select at least one visual object corresponding to the motion among the plurality of visual objects. The wearable device may obtain the sensor information based on the operation 1120 of FIG. 11. The wearable device may compare the motion indicated by the sensor information with a preset motion indicated by the object information corresponding to the plurality of visual objects. For example, the preset motion of the at least one visual object selected by the operation 1220 may correspond to the motion indicated by the sensor information.

Referring to FIG. 12, in an operation 1230, the wearable device according to an embodiment may change a rendering function applied to the at least one visual object selected by the operation 1220 based on the object information corresponding to the at least one visual object.

Referring to FIG. 12, in an operation 1240, the wearable device according to an embodiment may change the at least one visual object based on the changed rendering function. The wearable device performing the operations 1230 and 1240 of FIG. 12 may be performed similarly to performing the operation 1140 of FIG. 11.

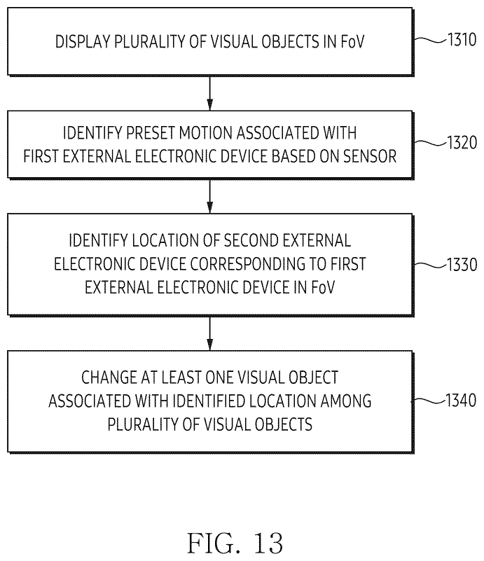

FIG. 13 illustrates a flowchart of a wearable device according to various embodiments. The wearable device of FIG. 13 may be an example of the wearable device 510 of FIG. 5 and FIG. 6. At least one of operations of FIG. 13 may be performed by the wearable device 510 of FIG. 6 and/or the processor 610 of FIG. 6. At least one of the operations of FIG. 13 may be associated with at least one of the operations of FIG. 11 and FIG. 12. The operations of FIG. 13 may be associated with the operation of the wearable device 510 described above with reference to FIG. 7. In the following embodiment, each of the operations may be sequentially performed, but is not necessarily performed sequentially. For example, an order of each of the operations may be changed, and/or at least two operations may be performed in parallel.

Referring to FIG. 13, in an operation 1310, the wearable device according to an embodiment may display a plurality of visual objects in a FoV. Similar to the operation 1210 of FIG. 12, the wearable device may perform the operation 1310 of FIG. 13.

Referring to FIG. 13, in an operation 1320, the wearable device according to an embodiment may identify a preset motion associated with a first external electronic device based on a sensor. The first external electronic device may include the first external electronic device 720 of FIG. 7. The preset motion associated with the first external electronic device may include, for example, a motion for releasing a contact between the first external electronic device and a body part of a user.

Referring to FIG. 13, in an operation 1330, the wearable device according to an embodiment may identify a location of a second external electronic device corresponding to the first external electronic device in the FoV. The second external electronic device, which is an external electronic device linked to the first external electronic device of the operation 1320, may include the second external electronic device 725 of FIG. 7. The wearable device may identify the location of the second external electronic device in the FoV based on frames outputted from a camera (e.g., the camera 640 of FIG. 6) disposed toward the FoV. The frames may include at least a portion of the FoV.

Referring to FIG. 13, in an operation 1340, the wearable device according to an embodiment may change at least one visual object associated with the location identified based on the operation 1330, among the plurality of visual objects. For example, as in the visual object 740 of FIG. 7, the wearable device may change at least one visual object overlapped on the second external electronic device viewed through the FoV. The wearable device may identify the at least one visual object overlapped on the location of the operation 1330, based on the frames. The wearable device changing the at least one visual object may include hiding the at least one visual object. The wearable device may perform the operation 1340 to improve visibility of the second external electronic device viewed through the FoV. The wearable device may perform the operation 1340 of FIG. 13 similar to the operation 1140 of FIG. 11 and/or the operations 1230 and 1240 of FIG. 12.

As described above, a wearable device according to an example embodiment may detect a motion using a camera and/or a sensor in a state of displaying a visual object indicated by object information. Based on the detected motion, the wearable device may change a shape, a color, a size, and/or a transparency of the visual object. For example, in order to enhance the visibility of an external object overlapped with the visual object, or to visualize a change in a linkage between the visual object and the external object by the motion, the wearable device may change the visual object.

In an example embodiment, a method of changing a visual object displayed by a wearable device based on a motion detected by the wearable device may be provided. As described above, according to an embodiment, the wearable device (e.g., the wearable device 510 of FIG. 5 to FIG. 6) may include a camera (e.g., the camera 640 of FIG. 6), a sensor (e.g., the sensor 650 of FIG. 6), a display (e.g., the display 630 of FIG. 6), and at least one processor (e.g., the processor 610 of FIG. 6). The at least one processor may be configured to display, in a state in which the wearable device is attached to a user, a visual object (e.g., the visual object 560 of FIG. 5, the visual object 740 of FIG. 7, the visual objects 825 and 840 of FIG. 8, the visual object 925 of FIG. 9, and the visual object 1025 of FIG. 10A and FIG. 10B) in a field-of-view (FoV) (e.g., the FoV 520 of FIG. 5) of the user by using the display. The at least one processor may be configured to obtain, from the camera and the sensor, sensor information indicating a motion associated with the user and identify whether the motion indicated by the sensor information corresponds to a preset motion in object information (e.g., the object information 670 of FIG. 6) matched to the visual object. The at least one processor may be configured to change, based on identifying the motion corresponding to the preset motion, the visual object displayed in the FoV, based on the object information matched to the preset motion. According to an example embodiment, the wearable device may enhance visibility of an external object occluded by the visual object, or visualize a linkage between the visual object and the external object, by changing the visual object.

In an example embodiment, the at least one processor may be configured to identify, based on identifying the motion corresponding to the preset motion associated with a first external electronic device (e.g., the first external electronic device 720 of FIG. 7) based on the sensor information, a second external electronic device (e.g., the second external electronic device 725 of

FIG. 7) included in frames of the camera and change, based on the object information, the visual object overlapped to the second external electronic device in the FoV.

In an example embodiment, the at least one processor may be configured to cease to, based on identifying the second external electronic device occluded by the visual object in the FoV, display the visual object based on the object information, or change a transparency of the visual object.

In an example embodiment, the at least one processor may be configured to change, based on identifying an external object changed by the motion, the visual object linked to the external object.

In an example embodiment, the at least one processor may be configured to change, based on at least one of a position or a shape of the external object being changed by the motion, the visual object.

In an example embodiment, the at least one processor may be configured to identify, based on frames which are outputted from the camera, at least one of the position, or the shape of the external object linked to the visual object.

In an example embodiment, the at least one processor may be configured to identify, based on frames which are outputted from the camera, a position relationship between the visual object and an external object linked to the visual object and identify, by comparing the identified position relationship and the object information, whether the motion corresponds to the preset motion.

In an example embodiment, the at least one processor may be configured to identify the external object indicated by the object information from the frames.

In an example embodiment, the at least one processor may be configured to identify the object information matched to the visual object based on an application for providing the visual object.

In an example embodiment, a method of a wearable device may include displaying (e.g., the operation 1310 of FIG. 13), in a state in which the wearable device is attached to a user, a plurality of visual objects in a field-of-view (FoV) of the user using a display in the wearable device; identifying (e.g., the operation 1330 of FIG. 13), based on identifying a preset motion associated with a first external electronic device based on a sensor in the wearable device, a location in the FoV of a second external electronic device corresponding to the first external electronic device; and changing (e.g., the operation 1340 of FIG. 13) at least one visual object associated with the location in the FoV among the plurality of visual objects, based on object information corresponding to the at least one visual object.

In an example embodiment, the displaying may include identifying, based on an application executed by a processor in the wearable device, the object information with respect to the plurality of visual objects and displaying, based on the object information, the plurality of visual objects.

In an example embodiment, the identifying may include obtaining frames which are outputted from a camera in the wearable device and including at least portion of the FoV and identifying the location in the FoV of the second external electronic device based on the frames.

In an example embodiment, the changing may include identifying, based on the frames, the at least one visual object overlapped to the position.

In an example embodiment, the identifying may include identifying, based on identifying the preset motion to release contact between the user and the first external electronic device based on the sensor, the location in the FoV of the second external electronic device.

In an example embodiment, the changing may include changing, based on a portion of the object information matched to the at least one visual object and the preset motion, a function to render the visual object in the display.

In an example embodiment, a method of a wearable device may include displaying (e.g., the operation 1110 of FIG. 11), in a state in which the wearable device is attached to a user, a visual object in a field-of-view (FoV) of the user using a display in the wearable device; obtaining (e.g., the operation 1120 of FIG. 11), from a camera in the wearable device and a sensor in the wearable device, sensor information indicating a motion associated with the user; identifying (e.g., the operation 1130 of FIG. 11) whether the motion indicated by the sensor information corresponds to a preset motion in object information matched to the visual object; and changing (e.g., the operation 1140 of FIG. 11), based on identifying the motion corresponding to the preset motion, the visual object displayed in the FoV, based on the object information matched to the preset motion.

In an example embodiment, the changing may include identifying, based on identifying the motion corresponding to the preset motion associated with a first external electronic device based on the sensor information, a second external electronic device included in frames of the camera and changing, based on the object information, the visual object overlapped to the second external electronic device in the FoV.

In an example embodiment, the changing may include ceasing to, based on identifying the second external electronic device occluded by the visual object in the FoV, display the visual object based on the object information, or change a transparency of the visual object.

In an example embodiment, the changing may include changing, based on identifying an external object changed by the motion, the visual object linked to the external object.

In an example embodiment, the changing may include changing, based on at least one of a position or a shape of the external object being changed by the motion, the visual object.

In an example embodiment, the changing may include identifying, based on frames which are outputted from the camera, at least one of the position, or the shape of the external object linked to the visual object.

In an example embodiment, the identifying may include identifying, based on frames which are outputted from the camera, a position relationship between the visual object and an external object linked to the visual object and identifying, by comparing the identified position relationship and the object information, whether the motion corresponds to the preset motion.

In an example embodiment, the identifying the position relationship may include identifying the external object indicated by the object information from the frames.

In an example embodiment, the displaying may include identifying the object information matched to the visual object based on an application for providing the visual object.

In an example embodiment, a wearable device (e.g., the wearable device 510 of FIG. 5 to FIG. 6) may include a sensor (e.g., the sensor 650 of FIG. 6), a display (e.g., the display 630 of FIG. 6), and at least one processor (e.g., the processor 610 of FIG. 6). The at least one processor may be configured to display, in a state in which the wearable device is attached to a user, a plurality of visual objects in a field-of-view (FoV) (e.g., the FoV 520 of FIG. 5) of the user using the display; identify, based on identifying a preset motion associated with a first external electronic device (e.g., the first external electronic device 720 of FIG. 7) based on the sensor, a location in the FoV of a second external electronic device (e.g., the second external electronic device 725 of FIG. 7) corresponding to the first external electronic device; and change at least one visual object associated with the location in the FoV among the plurality of visual objects, based on object information (e.g., the object information 670 of FIG. 6) corresponding to the at least one visual object.

In an example embodiment, the at least one processor may be configured to identify, based on an application executed by the processor, the object information with respect to the plurality of visual objects and display, based on the object information, the plurality of visual objects.

In an example embodiment, the wearable device may further include a camera. The at least one processor may be configured to obtain frames which are outputted from the camera and include at least a portion of the FoV and identify the location in the FoV of the second external electronic device based on the frames.

In an example embodiment, the at least one processor may be configured to identify, based on the frames, the at least one visual object overlapped to the position.

In an example embodiment, the at least one processor may be configured to identify, based on identifying the preset motion to release contact between the user and the first external electronic device based on the sensor, the location in the FoV of the second external electronic device.

In an example embodiment, the at least one processor may be configured to change, based on a portion of the object information matched to the at least one visual object and the preset motion, a function to render the visual object in the display.

The device described above may be implemented as a hardware component, a software component, and/or a combination of a hardware component and a software component. For example, the devices and components described in the example embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer devices and recorded on a computer-readable medium. In this case, the medium may continuously store a program executable by the computer or may temporarily store the program for execution or download. In addition, the medium may be various recording media or storage media in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

The disclosure has been described with reference to the embodiments. It would be appreciated by those skilled in the art that changes may be made to these embodiments without departing from the principles and spirit of the disclosure. Therefore, the disclosed embodiments are provided for the purpose of describing the disclosure and the disclosure should not be construed as being limited to only the embodiments set forth herein. The scope of the disclosure is defined by the claims as opposed to by the above-mentioned descriptions, and it should be understood that disclosure includes all differences made within the equivalent scope. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. A wearable device, comprising:
a camera;
a sensor;
a display;
memory comprising one or more storage media storing instructions; and
at least one processor comprising processing circuitry, wherein the instructions, when executed by the at least one processor individually or collectively, cause the wearable device to:
display, in a state in which the wearable device is attached to a user, a visual object in a field-of-view (FoV) of the user using the display;
obtain, from the camera and the sensor, motion information indicating a motion associated with the user;
identify whether the motion indicated by the motion information corresponds to a preset motion in object information associated with the visual object; and
change, based on identifying that the motion corresponds to the preset motion, the visual object displayed in the FoV, based on object information matched to the preset motion.

2. The wearable device of claim 1, wherein the instructions, when executed by the at least one processor individually or collectively, cause the wearable device to:
identify, based on identifying that the motion corresponding to the preset motion is associated with a first external electronic device, a second external electronic device included in frames of the camera; and
change, based on the object information, the visual object overlapped to the second external electronic device in the FoV.

3. The wearable device of claim 2, wherein the instructions, when executed by the at least one processor individually or collectively, cause the wearable device to:
cease to, based on identifying the second external electronic device occluded by the visual object in the FoV, display the visual object based on the object information or change a transparency of the visual object.

4. The wearable device of claim 1, wherein the instructions, when executed by the at least one processor individually or collectively, cause the wearable device to:
change, based on identifying an external object changed by the motion, the visual object linked to the external object.

5. The wearable device of claim 4, wherein the instructions, when executed by the at least one processor individually or collectively, cause the wearable device to:
change, based on at least one of a position or a shape of the external object being changed by the motion, the visual object.

6. The wearable device of claim 5, wherein the instructions, when executed by the at least one processor individually or collectively, cause the wearable device to:
identify, based on frames which are outputted from the camera, at least one of the position, or the shape of the external object linked to the visual object.

7. The wearable device of claim 1, wherein the instructions, when executed by the at least one processor individually or collectively, cause the wearable device to:
identify, based on frames which are outputted from the camera, a position relationship between the visual object and an external object linked to the visual object; and
identify, by comparing the identified position relationship and the object information, whether the motion corresponds to the preset motion.

8. The wearable device of claim 7, wherein the instructions, when executed by the at least one processor individually or collectively, cause the wearable device to:
identify the external object indicated by the object information from the frames.

9. The wearable device of claim 1, wherein the instructions, when executed by the at least one processor individually or collectively, cause the wearable device to:
identify the object information matched to the visual object based on an application for providing the visual object.

10. A method for a wearable device, the method comprising:
displaying, in a state in which the wearable device is attached to a user, a plurality of visual objects in a field-of-view (FoV) of the user using a display of the wearable device;
identifying, based on identifying a preset motion associated with a first external electronic device based on a sensor in the wearable device, a location in the FoV of a second external electronic device corresponding to the first external electronic device; and
changing at least one visual object associated with the location in the FoV among the plurality of visual objects, based on object information corresponding to the at least one visual object.

11. The method of claim 10, wherein the displaying comprises:
identifying, based on an application executed by a processor in the wearable device, the object information with respect to the plurality of visual objects; and
displaying, based on the object information, the plurality of visual objects.

12. The method of claim 10, wherein the identifying comprises:
obtaining frames which are outputted from a camera in the wearable device and including at least portion of the FoV; and
identifying the location in the FoV of the second external electronic device based on the frames.

13. The method of claim 12, wherein the changing comprises:
identifying, based on the frames, the at least one visual object overlapped to the position.

14. The method of claim 10, wherein the identifying comprises:
identifying, based on identifying the preset motion to correspond to releasing contact between the user and the first external electronic device, the location in the FoV of the second external electronic device.

15. The method of claim 10, wherein the changing comprises:
changing, based on a portion of the object information matched to the at least one visual object and the preset motion, a function to render the visual object in the display.

16. A method for a wearable device comprising a camera, a sensor, and a display, the method comprising:
displaying, in a state in which the wearable device is attached to a user, a visual object in a field-of-view (FoV) of the user using the display;
obtaining, from the camera and the sensor, motion information indicating a motion associated with the user;
identifying whether the motion indicated by the sensor information corresponds to a preset motion in object information associated with the visual object;
changing, based on identifying that the motion corresponds to the preset motion, the visual object displayed in the FoV, based on object information matched to the preset motion.

17. The method of claim 16, wherein the changing comprises:
identifying, based on identifying that the motion corresponding to the preset motion is associated with a first external electronic device, a second external electronic device included in frames of the camera;
changing, based on the object information, the visual object overlapped to the second external electronic device in the FoV.

18. The method of claim 16, wherein the changing comprises;
ceasing to, based on identifying the second external electronic device occluded by the visual object in the FoV, display the visual object based on the object information or changing a transparency of the visual object.

19. The method of claim 16, wherein the changing comprises:
changing, based on identifying an external object changed by the motion, the visual object linked to the external object.

20. The method of claim 16, wherein the changing comprises;
changing, based on at least one of a position or a shape of the external object being changed by the motion, the visual object.
